(19) United States
(12) Patent Application Publication
(10) Pub. No.: US 2015/0248649 A1
(43) Pub. Date: Sep. 3, 2015

(54) MOBILE DEVICE AND WEB BASED IMPLEMENTED APPLICATION TO OPTIMIZE EMPLOYMENT AND METHODS OF USE THEREOF

(71) Applicant: Roger Avats, Elwood (AU)

(72) Inventor: Roger Avats, Elwood (AU)

(73) Assignee: Roger Avats, Elwood (AU)

(21) Appl. No.: 14/611,266

(22) Filed: Feb. 1, 2015

Related U.S. Application Data
(63) Continuation of application No. 14/193,647, filed on Feb. 28, 2014.

(51) Int. Cl. G06Q 10/10; G06Q 50/00

(52) U.S. Cl. CPC G06Q 10/1053; G06Q 50/01

(57) ABSTRACT

The present invention is directed, in part, to a system and methods for human resources management and efficient, online and mobile guidance on assisting job seekers in locating and securing temporary or permanent job opportunities. More specifically, the present invention relates to a system and methods for performing substitute fulfillment, including identifying acceptable substitute employees/professionals, job opportunity review, real time employee availability, skill set review for employers/clients, appointment scheduling and establishing network connections amongst employers/clients and employees/professionals for both current and future job opportunities that arise in which qualified employees/professionals are paired with appropriate employers/clients whom are seeking to fill either temporary or permanent positions. Even more specifically, the present invention relates to a system and methods that employs online and mobile device capability by pairing available employees/professionals whom possess pertinent skill sets with employers/clients seeking to fill current or future works shifts or job opportunities with employees/professionals possessing such skill sets.

This application claims the benefit of U.S. application Ser. No. 14/193,647, filed Feb. 28, 2014, the substance of which is incorporated herein in its entirety

### FIELD OF THE INVENTION

The present invention relates generally to a system and methods for human resources management and efficient, online and mobile guidance on assisting job seeker in locating and securing temporary or permanent job opportunities. More specifically, the present invention relates to a system, system app and methods for performing for example, substitute fulfillment, including identifying acceptable substitute employees (permanent or temporary), job opportunity review, employee availability, skill set review for employers, appointment scheduling and establishing network connections amongst employers and employees for both current and future job opportunities that arise in which qualified employees are paired with appropriate employers whom are seeking to fill either temporary or permanent positions. Even more specifically, the present invention relates to a system and methods that employs online and mobile device capability by pairing available employees whom possess pertinent skill sets with employers seeking to fill current or future works shifts with employees within a desirable geographic location (i.e., situated in close proximity to the employment shift) possessing such skill sets. The invention further relates to an app-based network of employers, skilled workers, professionals and potential clients finding local business opportunities and staffing solutions in real time

### BACKGROUND OF THE INVENTION

Traditionally, staffing companies and online resources such as LinkedIn® and other websites match millions of people to millions of available job opportunities. By latest estimates, there is an average of 5 million people per day are employed by staffing companies. The prior art is replete with methods and systems used to match available and skilled employees to open job positions requiring specific qualifications and availabilities (i.e., temporary versus permanent, current or future) however, methods and systems currently known are similarly replete with shortcomings.

In that regard, social media and other online resources as well as mobile technology has provided another avenue by which employers and qualified employees can connect. Computer networks have given rise to a wide variety of online marketplaces providing employers and employees alike with the ability to buy and sell goods, exchange marketplace ideas and to generally connect with other individuals such as family and friends.

A commonly used approach to matching job candiates to open positions involves the identification of a candidate's skills so as to match the candidate with an open position requiring those skills. Although this has proven an effective way of locating employees possessing particular job skills, there are seemingly an endless myriad of other characteristics and factors that are not considered when using traditional candidate search methods. For example, current or future availability of the job candidate and their real time loation is rarely considered by traditional candidate search criteria. Also, whether a qualified candidate is seeking short term, long term, permanent or temporary work is rarely factored into current methods of identifying appropriate candidates to fill available job vacancies or shifts. Of practical concern is the often times need of an employer or client to retain the services of an employee or other professionals who are within a desirable geographic location, with the employee or professional able to take on employment almost at a moment's notice such as occurs during the course of a work day when an employee calls in sick or a client cancels an appointment during a particular busy day.

Another common approach to matching job candidates to open positions involves the use of directed questions to evaluate the job candidate. The results of the evaluation are used to compare the candidate to the open positions and identify a match, if any. As before, such methods still do not factor in other pertinent criteria related to matching qualified candidates to available job opportunities. Even in instances in which a small pool of candidates is ascertained for in-person interview, the lack of experience of many employers in conducting effective job interviews becomes a factor in what candidate is selected for the available position. As is often the case, job interviews by an employer is often merely “fit into” the supervisor's already busy work day and as a result, the interview process itself may fail to identify an appropriate candidate for the position. With the present system app claimed, a subscriber user can upload their current employer information (or provide a link to a site that holds their current information), number of recommendations, current shift that an employee or professional is working and for whom the shift is being worked and a list of a subscriber user's network connections so that an Employer or Client subscriber user can see if a particular subscriber user is currently connected via the system app to other employees.

Relating to the marketplace of temporary employment, the method of performing Substitute Fulfillment in matching qualified candidates with appropriate employment opportunities has been one of particular interest in the online and mobile device industries. Substitute Fulfillment is generally understood as a process of locating a replacement employee to fill a temporary employee absence in an organization. The method however has been found to be an unreliable, labor-intensive process.

In any organization, the absence of an employee critical to on-going operations can have a perceptible negative impact in the particular business affected. Other factors that may be important in filling a temporary position within an organization include fulfillment of pending deadlines and ensuring that workflow and productivity is maintained throughout the absence of the permanent employee as well as maintaining and/or enhancing customer service.

In order to ensure that the urgency and importance of filling both permanent as well as temporary employment opportunities and matching those opportunities to qualified employees are addressed, a novel system and methods are warranted. As the world has grown smaller due to the advent of mobile phone and technology, newer methods of connecting qualified employees with available job opportunities are needed more than ever.

Accordingly, shortcomings in the field of employee and employment opportunity matching, remain. Further, existing solutions fail to address particular deficiencies that confront businesses and consumers seeking alternatives to the existing art and a solution to advancing efficient and accurate job matching for both employees and employers remains elusive. The present invention addresses these shortcomings.

### SUMMARY OF THE INVENTION

The present invention is directed to an improved method and system for efficiently and accurately matching qualified and available employees/professionals to employment opportunities either currently available or which may become available in the short to long-term future. The invention further relates to providing job seekers with a mobile device-based and implemented application as well as an online method of presenting their qualifications and skill sets to potential employers on a global scale. Likewise, the mobile application (i.e., “app”) and online interface allows employers/client subscriber users to communicate to qualified employees/professional subscriber users on a global scale regarding job opportunities that are either temporary or permanent in nature and which may be currently available or which may be available in the near future. The system allows employer/client subscriber users the ability to provide the global community with highly specific details and requirements related to the positions or services required and employment opportunities they are looking to fill.

The present invention is further directed to an improved method and system of matching qualified and available employees with job positions or services that are currently available or positions or services that will shortly become available to such employees or professionals. The system and method further allow the job seekers as well as employers and clients to establish networking contacts by which current or future employment opportunities can be discussed and positions and jobs filled. The invention allows for efficient and accurate matching of employees/professionals and employers/clients in a convenient and mobile application “app” which can also be accessed via the Internet.

As described, the system and methods herein allow for a novel manner in which employers/clients can fill current and future available positions and required services with employees/professionals possessing qualifications tailor fit for the positions/services in which they seek to fill. Included and within the scope of the mobile-device implemented system application described herein is also an improved system and method of identifying and locating replacement workers to fill a temporary employee absence in an organization, also known as a substitute fulfillment system. In order to optimize the value and utility of the claimed system app, it is imperative that network connections be established so that employee/employer and client/professional working relationships can be established. In other words, the more network connections a subscriber user has associated with their system app account, the easier and more efficiently job opportunity relationships, and therefore job opportunities, will arise. Likewise the system and methods described herein allow employers/clients to network and “connect” with potential employees/professionals, on a global scale, and to match their own qualifications to only those employers/clients that require such qualification thus, negating the wasteful practice of resume mass mailing and interviews by supervisors unaccustomed to conducting effective interviews that will produce the best candidate for their position.

The system platform and software of the invention is a communications platform that enables employers to recruit and retain trusted employees. Recruit means someone for the next half hour, or someone for next week or someone to replace someone who will be leaving in a month. Currently employers do not have a single place to look for employees to come in to work whether it is for near term or longer term. The invention will offer them the ability to see potential employees who are located in their geographic area with the skill sets and availability that they desire with a filter to show employees who have said that they would “Like to Work Here.” Additionally, they can see where these employees have worked along with the number of shifts respectively with the associated ratings and their resume or CV. Finally, this system provides the ability to send and receive video messages between the employer/client and employee/professional to send and receive interview questions and answers. This is utilized to screen the suitable candidates further without either party having to spend time for an in person interview that requires travel and setting up of appointments.

Retain means that the employees of the employers will stay longer because they will be able to find other work or a second job and easily manage to work in all locations getting the number of hours of work they desire when they desire to work it. For example, many employers are not in a position to offer the number of hours that their employees want hence causing the employees to seek a different job with a different employer. The invention enables the employees to see on a map the other employers who are on the system platform and they can “Like to Work Here” or see if that employer has current job vacancies

### BRIEF DESCRIPTION OF THE DRAWINGS

FIGS. 1A and 1B depict a mobile device displaying an introductory electronic page of the invention. The illustration depicts the initial access page of the mobile app wherein a subscriber can access the get started page, login page or what is Open Sim Sim video. Illustrations provided herein depict electronic pages of the embodiments as they are displayed on a mobile device (i.e. left side of illustration) as well as the entirety of the electronic page wherein a subscriber will need to scroll down on the mobile or internet interface to view the remainder of the page provided in order to view it (i.e., right side of illustration).

FIGS. 2A and 2B depict an electronic page text area and login screen wherein a subscriber user enters login user name, email and/or mobile number, password information and agree to the terms and condition in order to gain access to the network and methods of the invention. In addition, subscriber users have the option to register/login via their Facebook® credentials. The illustration further provides a button that allows the user to advance to the next page by pressing the “Next” button.

FIGS. 3A and 3B depict a subsequent electronic page on a mobile device wherein a subscriber user is able to enter experience and job skills to their subscriber account. The page also depicts buttons wherein a subscriber can push a button in order to begin searching to invite possible network connections or search for subscribers who can fill a shift or job opportunity (i.e., employers, employees, professionals and clients).

FIGS. 4A and 4B illustrate the electronic page on a mobile device wherein a subscriber user enters skills and qualifications to their subscriber account with such information also including hourly pay rate and pertinent skills.

FIGS. 5A and 5B illustrate an additional electronic page on a mobile device related to the “skills” portion described in FIG. 4. More specifically, the illustration provides an electronic page wherein the subscriber user can view their skills, recommendations and enter additional job history and previous work history.

FIGS. 6A and 6B illustrate an electronic page on a mobile device which shows a subscriber user profile electronic page in which a subscriber user can edit or enter additional information regarding the user's background, experience and qualifications. Also depicted, specifically in 6B is the subscriber user's availability for taking available job opportunities.

FIGS. 7A and 7B illustrate an electronic page on a mobile device wherein a subscriber can edit their subscriber account including the ability to add birth date and add a professional photograph therein.

FIGS. 8A and 8B illustrate an electronic page on a mobile device wherein a subscriber user can add the user's current and future availability for taking on new job opportunities including the ability to add preferred hourly wage and job type sought.

FIGS. 9A and 9B illustrates an electronic page on a mobile device wherein a subscriber user can view their current availability information and/or add detail to the user's availability to accept employment opportunities.

FIGS. 10A and 10B illustrates an electronic page on a mobile device wherein a subscriber user can edit the user's availability and further, the user is able to forward the updated availability to employer/client contacts within the user's network of connections.

FIGS. 11A and 11B illustrate an electronic page on a mobile device wherein a subscriber user establishes a specific time and date for which the user will work. The page further allows an employer/client subscriber user to assign the available position to the employee subscriber user by pressing the “Book Me” button.

FIGS. 12A and 12B illustrate an electronic page of the invention on a mobile device wherein a subscriber user can forward or “push” the subscriber user's availability to other subscriber users that may have an interest in employing the subscriber user.

FIGS. 13A and 13B illustrate an electronic page of the invention on a mobile device display wherein either a subscriber user can search for potential employees or employers respectively to connect with. A Subscriber user can also access their contact list on their mobile device and invite contacts to connect with. Subscriber users can set up an account to be an employer and employee as appropriate.

FIGS. 14A and 14B illustrate an electronic page of the invention on a mobile device display wherein subscriber user are able to accept or ignore new network and account “connections” and contacts with whom there is potential in working together in a particular business capacity.

FIGS. 15A and 15B illustrate an electronic page of the invention on a mobile device display wherein a subscriber user (employee, employer, professional and/or client) can edit the user's particular account profile.

FIGS. 16A and 16B illustrate an electronic page of the invention on a mobile device display wherein a subscriber user can edit and add search and filtering criteria when either searching for job opportunities or in searching for qualified candidates to fill available job positions or shifts. Specifically, the page displays the ability to filter search criteria and limit such criteria to remain for example, within a certain mileage.

FIGS. 17A and 17B depict an electronic page of the invention on a mobile device display wherein an employer subscriber user adds a new job opportunity that has become available with the user's company. The page allows job details to be added to screen and provides a button by which employee/professional subscriber users can apply.

FIGS. 18A and 18B illustrate an electronic page of the invention on a mobile device display wherein posted employment opportunities are listed. The page provides specifics including for example, time and date on which the job opportunity must be undertaken. With regard to FIG. 18B, the illustration provides work positions and/or opportunities that have been accepted, positions and/or opportunities that are generally posted and newly posted positions and/opportunities on a subscriber user's account.

FIGS. 19A and 19B illustrate an electronic page of the invention on a mobile device display wherein an employer/client subscriber user can enter search criteria in which to fill an available job position.

FIGS. 20A and 20B illustrate an electronic page of the invention on a mobile device display wherein the results of the search and search criteria entered in FIGS. 19A and 19B are generated and displayed. FIG. 20B illustrates a subscriber user's ability to “push” or forward the position to subscriber user's within their network.

FIGS. 21A and 21B illustrate an electronic page of the invention on a mobile device display wherein the dates and times for a job opportunity are displayed and viewable by subscriber users.

FIGS. 22A and 22B illustrate an electronic page of the invention on a mobile device display that communicates to an employer/client subscriber user that one more employee/professional subscriber users has applied for the job position posted including for example the name and date and time of the position applied for.

FIGS. 23A and 23B illustrate an electronic page of the invention on a mobile device display in which an employee/professional subscriber user views in the instance in which the user has been offered the opportunity to work an available position for which the employee/professional subscriber user has applied for and has been accepted to fill the shift and/or job.

FIGS. 24A and 24B illustrate an electronic page of the invention on a mobile device display wherein a subscriber user can create a corporate profile including for example, the name of the business, the industry type as well as size of the business.

FIGS. 25A and 25B illustrate an electronic page of the invention on a mobile device display wherein an employer subscriber user who is an administrator of a business is able to locate suitably qualified employee/professional subscriber users whom can fill an available job position on the employer/client subscriber user's list of job postings. The administrator or the business can invite other subscriber users to join their connections.

FIGS. 26A and 26B illustrate an electronic page of the invention on a mobile device display wherein the business information created by an employer/professional subscriber user is displayed. The page provides among other details, name and available positions at the business listed.

FIGS. 27A and 27B illustrate an electronic page of the invention on a mobile device display in which an employee/professional subscriber user can email or call to inquire about a particular position posted by an employer/client subscriber user for a business.

FIG. 28 illustrates a preferred embodiment of the hardware and software backend of the invention as it relates to the software and “app”. As shown, the illustration illustrates the relationship between the software app and the Amazon Web Services environment that will host the app.

FIG. 29 illustrates yet another preferred embodiment of the architecture of the invention as it relates to the backend hardware/software components of the software system app. As shown, the illustration includes the technologies used in the development of the app for each of the associated layers (mobile, desktop and back-end) and the requirements to operate and display the software app on for example, a mobile device.

### DETAILED DESCRIPTION OF THE INVENTION

The present invention provides a system, system app and methods that efficiently and accurately match qualified employee/professional subscriber users with suitable employer/client subscriber users so that job opportunities (i.e., temporary or permanent, current or future) can be filled with appropriately qualified and experienced individuals. The mobile device implemented job placement and recruitment system and methods allows subscriber users to establish account “network connections” with other subscriber users whom may be employers/clients or employees/professionals. The system and methods allows subscriber users to be either an employee/professional subscriber user (job seeker) or an employer/client subscriber user (job provider or a user searching for a service) depending on the needs and provisions of the subscriber user. Subscriber users can also be both an employee subscriber user as well as a employer subscriber user. Likewise, subscriber users can be designated as a client subscriber user, a professional subscriber user or both. Therefore, the present invention is an app-based network of employers, skilled workers, professionals and potential clients finding local business opportunities and staffing solutions in real time.

For instance, an employer subscriber user can post an available position on the employer subscriber user's account profile but the employer subscriber user can also be an employee subscriber user if that user chooses to apply for a position posted on the app. In other words, a subscriber user can be either an employer subscriber user, an employee subscriber user, professional subscriber user, client subscriber user or they may be all four. Included and within the scope of the mobile-device implemented system application described herein, is also an improved system and method of identifying and locating replacement workers to fill a temporary employee absence in an organization, also known in the field of professional staffing as a substitute fulfillment system.

From a practical perspective, the service sector subscriber users have multiple jobs and there is a need to optimize the effective utilization of skills, location and availability using real time push notification and geomapping to establish reliable estimated time of arrival (ETA) for employees/professional to job sites where they are needed. The social networking application or system app, solves the “just in time” need of filling work shifts or opportunities by connecting employees and professionals to all their employers and clients respectively, so that there is instant visibility of available individuals by their skills, time of day, day of week, hourly rate, review and ETA information.

With the claimed social networking application or system app, a user can upload their current employer/client information (or provide a link to a site that holds their current information), past employer/client information, number of recommendations, current shift or opportunites the employee/professional is working and for whom the employee/professional is working those shifts or jobs for, and the employee's/professionals list of connections so that an employer/client can see if an employee or professional subscriber user are currently connected to other employees/professional for the business.

With the claimed social networking system, the more people that are connected the greater the opportunity is for users to begin quickly and efficiently filling available job positions or job shifts on a real time basis. Unlike LinkedIn® and Monster®, users of the social networking system gain real time monetary benefit through their connections and gaining more work through real time availability updates. Accordingly, the more connections, the more opportunity to secure additional work resulting in subscriber users having a tangible reason (monetary benefit) to actively invite more and more network connections.

In a preferred embodiment, the system and methods are accessed via a mobile device application (i.e., “app”) or through a website interface. In this embodiment, the app is downloaded to a mobile device. Thereafter, the user is able to create a user account wherein the user enters details including but not limited to name, mailing address and phone information, email address and qualifications including any and all information typically found in an individual's resume. In this preferred embodiment, individual users entering prior work history and experience are deemed an employee/professional subscriber user.

Included in the preferred embodiment, a subscriber user can create an account profile wherein the user enters details including but not limited to corporate name, business size, location and contact information. The subscriber user in this instance can also post available job opportunities for which employee/professional subscribers can view and apply to such positions or opportunity. Subscriber users whom post corporate information and available job opportunities are deemed employer or client subscriber users however, within the scope of the invention is the allowance of an employer/client subscriber user to also act as an employee/professional subscriber user should the employer/client subscriber user ever choose to apply for available position and/or opportunity that are posted on the interface app.

As described herein the mobile “app” and/or website interface allows an employee/professional subscriber user to view available job positions and opportunities in real time and further allows them to apply for only those positions and/or opportunities to which their background and qualifications best fit. Also as described herein, the mobile app and/or website interface of the invention allows an employer/client subscriber user to post positions and/or opportunities that are either currently available or positions and/or opportunities that will be available in the future, providing potential employee/professional subscriber users with detailed information relating to the position including but not limited to time and date required for the position and/or opportunities, location and place of employment, qualifications required and other employer/client contact information necessary including hourly rate.

It is therefore, a primary object of the present invention to provide a system and methods, employing a mobile device app and/or website interface, that efficiently and accurately match suitably qualified employee/professional subscriber users to available job positions and/or opportunities and employers/clients seeking such employees/professional for either temporary or permanent work, or for current or future work. In addition to the specific definitions provided below, each of the terms employed in the claims are understood to have a similar meaning and understanding as the terms are generally known and accepted to hold in the art.

The term “subscriber user” as used herein refers to an individual whom has created a user account and profile on the app and/or website interface, who is seeking current or future employment or alternatively, an individual whom is seeking a qualified job candidate that can fill an available position and/or opportunity.

The term “employee subscriber user” as used herein refers to an individual whom has created a user account on the app and/or website of the invention whom posts details regarding their professional background, work history and experience so that the information is available to potential employers. The term also refers to, among other things, an individual whom searches the app's database for available positions that are posted by employers on the app and/or website and to those individuals whom apply for such positions by forwarding their real time availability, recommendations, hourly rate and qualifications to employers in need of such employees.

The term “employer subscriber user” and the like, as used herein refers to an individual whom has created a user account on the app and/or website of the invention whom posts the need of an employee possessing particular skills and experience for a position available currently or in the future at the employer subscriber user's business. The term also refers, among other things, to an individual whom searches the app's database for qualified applicants whom possess skills and experience necessary in order to fill the employer subscriber user's needs.

The term “professional subscriber user” and the like, as used herein, refers to an individual whom has created a user account on the system app/or website of the invention whom is seeking to provide services for pay to other subscriber users on the system app. The individual as designed hereto will possess skills that can be marketed in a posting produced by the professional subscriber user on the system app describing among other things, real time availability, geographic location of the professional, hourly rate, recommendations and professional skills.

The term “client subscriber user”, “client user” and the like, refers to an individual whom has created a user account on the system app/or website of the invention whom is seeking the services of another subscriber user's professional skills. For example, a client subscriber user will advertise their need of a specific and particular skill set and professional background by posting such need on the system app with requirements including for example, skill set, geographic location, date/time required, requested pay rate to perform the needed job duties and list of qualifications sought.

The term “available”, “availability” and the like, as used herein, as it relates to employee subscriber users refer to the employee subscriber user's ability to accept employment either presently or in the future. The term “available”, “availability” and the like as used herein, as it relates to employer subscriber users refers to the employer subscriber user's ability to provide a job opportunity either presently or in the future.

The term “app”, “application” and the like, as used herein refers to a self-contained program or piece of software designed to fulfill a particular purpose. As described herein, an application is a software program or piece of software that can be downloaded by a user to a mobile device.

The term “situated” and the like as used herein, refers to the presence and availability of a subscriber user within a specified geographical location so that the geographical location in which the subscriber user is located fulfills the job requirements specified in one or more job opportunities posted on the system application. For example, used herein, a job posting can require that a prospective employee subscriber must reside within a 10-mile radius from the job site. In the instance in which an employee subscriber user resides within a 10-mile radius of the job site, that employee subscriber user is appropriate situated to fulfill the requirements of the job description and requirements.

The term “Geomapping”, “Geo Location”, “Geo mapping” or the like as used herein refers to identification of the real-world geographic location of subscriber users of the system application so that it can assess location (street address) of subscriber users relative to one other for the purpose of determining distance, travel time, and estimate time of arrival to meet between users.

The term “connection”, “network connection” and the like as used herein refer to the establishment of a network relationship between two or more individuals for the purpose of employing use of the invention. For example, a “connection” or “network connection” is established when one subscriber user employs use of the invention to reach out to other subscriber users in order to form a relationship using the aspects of the invention for the purpose of conducting current or future business with one another. The term “connection”, “network connection” as used herein, will also be connoted as a noun in which a “connection” or “network connection” will be referred to as a subscriber user whom has established a network or “app” relationship with another subscriber using the aspects of the invention that are attributed to establishing such relationships. Likewise, the term “connection”, “network connection” and the like as used herein is intended to occupy the same meaning and understanding as is known in the current and prior art. A “connection” or “network connection” and like terms, can refer to employee subscriber users as well as employer subscriber users, professional subscriber users, as well as client subscriber users.

The term “invite”, “invitation” and the like as used herein refer to the extension of the opportunity to establish a connection from one subscriber user to another. For example, as described herein, one subscriber user can, by employing the aspects of the invention app, forward an invitation to another subscriber user with the opportunity to form a relationship on an app or website account for the purpose of conducting current or future business or for the purpose of advancing job opportunities. The term “push invite” as used herein refers to one subscriber user extending an offer of a network relationship to another.

The term “active job”, “active job opportunity” and the like as used herein refer to the existence of a job opportunity to which an employee subscriber can pursue via use of the app invention. The “active job”, “active job opportunity” is intended to refer to job opportunities that are currently available and also those to which will be available in the future. For example, an “active job” can refer to a job opportunity that isn't scheduled to begin until a future, definitive date.

The term “directly hired”, “directly”, “hired directly” or the like as used herein, refers to the hiring of an employee or professional subscriber user by an employer or client subscriber user respectively for services. For example, the employer or client subscriber user will be in a position of paying the employee or professional subscriber user respectively, directly with no third party job placement entity. In such, a direct employee/employer or professional/client business relationship, the employee or professional will be paid directly by the employer or client subscriber user.

The term “members”, “member subscriber” or the like as used herein, refers to an individual whom has fulfilled the requirements of subscription and has been given the right to use the system application of the invention. For example, a member of the system network application will generally provide among other things, name, user name, a password, a subscription fee and other contact information prior to being given the ability to use the system network application.

The term “potential employee subscriber user”, “potential professional subscriber user” and the like as used herein refers generally to an employee or professional subscriber user whom possesses professional qualifications and job skills that match the requirements outlined in a job posting created by an employer/client subscriber user. The term also includes an employee or professional subscriber user that is able to conduct work toward the one or more job opportunities within the day and time schedule requirements and further, includes an employee subscriber user that is located, geographically, within a desirable vicinity to the one or more job opportunities as outlined in the job requirement descriptions posted by the employer subscriber user. Likewise, a “potential employer subscriber user”, “potential client subscriber user” or the like, as used herein refers to a client or employer subscriber user that has posted one or more job opportunities on the system application wherein the required qualifications of the posted position match the background and professional qualifications of one or more employee or professional subscriber users.

The term “recommendations” and the like as used herein refers to the ability of subscriber users to prepare a critique of another subscriber user's work performance upon the completion of one or more jobs/shifts by an employee/professional subscriber user. For example, an employer/client subscriber user can write a recommendation related to the work performance of an employee/professional subscriber user whom the employer/client subscriber user hired for one or more job/shift opportunities, once the job(s)/shift(s) have been completed, with the recommendation being postable on the employee subscriber user's profile account.

The term “push notification”, and the like as used herein generally relates to either employer/client subscriber users, employee/client subscriber users or to both and generally refers to the system application providing a means to a subscriber user to either actively or automatically sending job and professional background information via the system application. Specifically, as it relates to employee/professional subscriber users, such users can actively (i.e., manually) push their professional qualifications and interest to an employer/client subscriber user for a particular job/shift that the employer/client subscriber user has posted on the system application.

Similarly, “push notification” is accomplished automatically wherein the system application employs software that automatically sends out, on behalf of employee/professional subscriber users, the professional background and job experience of employee/professional subscriber users, to open job/shift opportunities that have been posted by employer/client subscriber users. For example, an employee/professional subscriber user can push their account information to directly either to an employer/client subscriber user's account or to one or more job opportunities posted on the system application. Likewise, employer/client subscriber users can push their account information and/or one or more job opportunities directly to employee/professional subscriber user's accounts whether those employee/professional subscriber users are within the employer/client subscriber users network or not.

Likewise, an employer/client subscriber user can actively push one or more job/shift opportunities to prospective employee/professional subscriber users to notify the employee/professional subscriber users of the existence of the job opportunities. Similarly, “push notification” is accomplished automatically, on behalf of employee/client subscriber users, wherein the system application employs software that automatically sends out open job/shift opportunities to prospective employee/professional subscriber users that the system application determines to be a match for the one or more job opportunities.

The term “results list” and the like as referred to herein, generally relates to the ability of the system application to allow a subscriber user (i.e., employer/client and/or employee/professional) to conduct searches. For example, as it relates to an employer/client subscriber user, such users can enter search criteria into the system application software, conduct the desired search for potential employee/professional subscriber users whom possess job qualifications that match job opportunities that the employer/client seek to fill. Upon conducting such a search, a list of potential employee/professional subscriber users that match job requirements is generated by the system application. The list generated is generally referred to as a “results list” or an employer/client results list.

As the term relates to searches conducted by employee/professional subscriber users, the system application allows such users to search for one or more job opportunities that are currently available on the system software which possess job qualification requirements that match the employee/professional subscriber user's experience and job skills. Upon conducting the search, a list of available job opportunities will be generated by the system application. This list, as it relates to employee/professional subscriber users is generally referred to as a “results list” or an employee/professional results list.

The term “job, employment opportunities” and the like as used herein, generally refers to both permanent and temporary work. The term also describes and is intended to include work that is merely part of an available shift, a whole shift, one week or longer, whether on a permanent or temporary type basis. The job opportunities of the invention generally relate to direct hiring (i.e., either temporary or permanent) of the employee/professional subscriber user by the employer/client subscriber user. In other words, there are no third parties involved in the retention of an employee/professional subscriber user to perform job opportunities. As envisioned herein, employer/client subscriber users act to employ employee/professionals directly.

The term “real or active time push notification” and the like as used herein refers to immediate notification by an employer/client subscriber user, employee/professional subscriber user or to both by either active (i.e., manual) or automatic notification of a potential match between an employee/professional subscriber user's background qualifications and the requirements of one or more job opportunities posted by an employer/client subscriber user. An example of a real time push notification can occur wherein an employee/client subscriber user is no longer able to work for which the employee was previously hired. In real time push notification the employee/client in such a scenario is able to immediately update his lack of availability for the job so that the employer/professional subscriber can set out to immediately locate a suitable alternative. In such a notification, in this scenario, the employee/client subscriber user can thereafter immediately update their availability for other new job opportunities. Further, “actively pushing” a notification herein refers to the deliberate effort by a subscriber user to forward employment opportunity information to another subscriber user. Pushing can also be completed automatically by means of the system application software.

The term “declines” as used herein generally refers to the instance in which an employee/client subscriber user has reviewed the job qualifications and professional experience associated with an employee/professional subscriber user that has applied to one or more job opportunities posted by the employee/client subscriber user on the system application and has decided not to retain the services of the employee/professional subscriber user for the one or more job opportunities. In the instance in which the employee/client subscriber user chooses not to hire the potential employee/professional subscriber user, the employer/client subscriber user chooses and selects the “Ignore” button on the system application and therefore declines the prospective employee/professional from further consideration with regard to the one or more job opportunities.

It is to be understood that the invention described herein refers to an app or application as well as an interface functionality via an online website. Individuals can access the system and employ use of the methods described herein by either mobile device and/or by accessing an online website via the Internet. Once the individual has established an account with the mobile and web based system, the individual, now referred to as a subscriber user, will be able to access account information, including all its functionality, by either mobile device or online via website.

Technologies employed in creating and implementing the application (i.e., “app”) for uses by a subscriber user are generally known in the art and include the following attributes. With regard to the backend layer of the software, PHP>=5.3.20 for example is employed with a Laravel programming framework. Included in the framework is Cartalyst Sentry 2, League OAuth2 Server, League OAuth2 Server Laravel and PHPUnit Laravel wrapper. With regard to the frontend desktop layer, Javascript is employed with Ember and Ember Data also on the front end. With regard to the frontend mobile layer, Phonegap is used to create a mobile wrapper for a web application. Server infrastructure is for example, Nginx (proxy server), Apache (http server), MySQL (database) with all services carried by Amazon Web Services or other similar platforms. It is to be understood that the attributes described herein which act to create and implement the invention are preferred embodiments however, other network software packages that can similarly set up the invention and as are known in the art are also envisioned and within the scope of the present invention.

As utilized, the invention herein allows several types of subscriber users to use the invention. For example, as described, an employer subscriber user is generally understood to be an individual in general or specific need of another individual whom can be employed either on a permanent or temporary basis, whether currently or in the future. An employee subscriber user is generally an individual in need of additional or new employment opportunities whether temporary in nature or permanent, either current or in the future.

Professional subscriber users are also envisioned in the present invention and can be generally be described as individual possessing skills that are currently available for hire by other individuals. It is to be understood that Professionals in this capacity will be similarly situated to employee subscriber users currently seeking new or additional job opportunities. In addition to Professionals is the existence of Clients whom can be generally described as individuals who are currently in need of another individual to provide professional services whether on an on-going basis or on a temporary basis. It is to be understood that Clients will occupy this designation and are similar in nature to employer subscriber users whom are currently in need of employees who possess a desired skill set and qualifications so to fill an available job opportunity.

The process by which each subscriber user type employs use of the claimed system and methods can be summarized as follows and merely represent examples of its use and therefore, do not limit the scope of the invention: Users can perform scenarios depending on their particular circumstance. (i.e.; I could be an (employer subscriber user) who is working as a manager in a restaurant, offering personal training session as a (professional subscriber user), working as a bartender (employee subscriber user) on weekends and also looking for an electrician (client subscriber user) for some electrical work needed at my house.) Further, a subscriber user can push open shifts and/or jobs, which may include special notes (i.e. I have had a last minute cancellation, so am willing to offer this session at a 20% discount to my normal rate if you take this session).

Employer Subscriber User Example: A typical Employer is a user that has one or more employees working for them and wants to post shifts to available staff and view/filter their staff details.
1. Download app via but not limited to App Store®, Google® play or OSS® website Employer is presented with the homepage with three options, Get Started, Login and What is OpenSimSim®.
2. Employer will register using a unique email address or cell phone number along with a valid password and agreeing to the terms and conditions. Employer can also register using their Facebook® credentials.
3. Once registered an employer will login using their login details.
4. Employer will create a business with the following attributes.
   Business name
   Industry
   Size (number of employees)
5. Employer will setup business profile, which includes an overview about the business, availability by date and time (this could simply be the hours of operation) along with their settings and notification rules.
6. Employer will connect with employees via a connection request.
7. Employer will assign administrative roles to other managers.
8. Employer will be able to view employee's availability by skill, date and times.
9. Employer will be able to push available shifts to their employees or the OSS® world.
10. Employer will be able to view employees who are interested in filling the open shifts. This includes hourly rate, reviews and ETA. This could be a current employee or other candidates that are not current employee but have the needed skill set.
11. Employer will be able to select most appropriate employee for the given shift. This could be a current employee or other candidates that are not current employee but have the needed skill set.
12. Employer can add reviews to employee's profile.
13. Employer can provide feedback to the OpenSimSim® team regarding the application.

Employee Subscriber User Example: A typical Employee is a user who has a working arrangement with one or more employers. (i.e. I am a bartender for Restaurant A and also a waitress at the country club).
1. Download app via but not limited to App Store®, Google® play or OSS website. Employee is presented with the homepage with three options, Get Started, Login and What is OpenSimSim®.
2. Employee will register using a unique email address or cell phone number along with a valid password and agreeing to the terms and conditions. Employee can also register using their Facebook® credentials.
3. Once registered an employee will login using their login details.
4. Employee will send out connection request.
5. Employee will be able to accept connection request.
6. Employee will setup their skills, which includes a skill overview and the hourly rate by skill.
7. Employee will add their real time availability by skill, time of day and repeat cycle.
8. Employee can push out availability changes.
9. Employee will setup their profile, which includes a bio, picture, skills (reviews for skills which can be removed), setting and notification.
10. Employee can search for available shifts from current employer or other businesses in the area.
11. Employee can view shifts that have been posted by their employer.
12. Employee can express interest in the shift.
13. Employee can view all accepted shifts, all jobs they have posted, along with all new shift opportunities.
14. Employee can provide feedback to the OpenSimSim® team regarding the
application.

Professional (i.e., Employee) Subscriber User Example: A Typical Professional is someone offering a service. (Plumber, personal trainer, golf instructor, babysitter and dentist to name a few). This type of user will have available slots of time, which they can offer to potential clients. (i.e. I am a personal trainer and have a last minute cancellation; I can push out my availability offering a discount to anyone who want to take the session.)
1. Download app via but not limited to App Store®, Google Play® or OSS® website.
2. Professional is presented with the homepage with three options, Get Started, Login and What is OpenSimSim®.
3. A Professional will register using a unique email address or cell phone number along with a valid password and agreeing to the terms and conditions. Professional can also register using their Facebook® credentials.
4. Once registered a Professional will login using their login details.
5. A Professional can create a business with the following attributes.
   Business name
   Industry
   Size (number of employees)
6. A Professional will send out connection request.
7. A Professional will be able to accept connection request.
8. A Professional will setup their skills, which includes a skill overview and the hourly rate by skill.
9. A Professional will add their real time availability by skill, time of day and repeat cycle.
10. A Professional can push out availability changes.
11. A Professional will setup their profile, which includes a bio, picture, skills (reviews for skills which can be removed), setting and notification.
12. A Professional can search for available jobs.
13. A Professional can view jobs that have been posted by their clients or potential clients.
14. A Professional can express interest in a job posted.
15. A Professional can see all jobs that have been assigned to them.
16. A Professional can view all accepted jobs, all jobs they have posted, along with all new job opportunities.
17. A Professional can provide feedback to the OpenSimSim® team regarding the application.

Client (i.e., Employer) Subscriber User Example: A typical Client is a user looking for a service. (i.e. I need a Plumber on Friday morning. I need a golf instruction on Saturday morning.)
1. Download app via but not limited to App Store®, Google Play® or OSS® website. Client is presented with the homepage with three options, Get Started, Login and What is OpenSimSim®.
2. A Client will register using a unique email address or cell phone number along with a valid password and agreeing to the terms and conditions. A Client can also register using their Facebook® credentials.
3. Once registered a Client will login using their login details.
4. A Client will send out connection request.
5. A Client will be able to view the availability by skill, date and times of their connections.
6. A Client will be able to push available push available jobs to their connection and the OpenSimSim® world.
7. A Client will be able to view professionals who are interested in filling the advertised job. This includes hourly rate, reviews and ETA.
8. A Client will be able to select most appropriate user for the advertised job.
9. A Client can add reviews to a users profile for a service fulfilled.
10. A Client can provide feedback to the OpenSimSim® team regarding the application.

It is to be understood by those of pertinent skill in the art that subscriber users will occupy different user designations depending on their own particular needs. For example, an employer subscriber user can post a position currently available with their business while simultaneously acting as an employee subscriber user in applying to an available temporary or seasonal position with a business other than their own. Professional subscriber users whom seek employment opportunities by posting their availability on the system will seek available positions and push their availabilities to their respective connections and even to those subscriber users that may be outside the network connections of the Professional subscriber user seeking to sell their services. Likewise, a Client subscriber user occupies a similar position as an employer subscriber user as the Client subscriber user will post positions on their profile that they wish to have filled by one of pertinent skill and professional background.

Methods of the mobile device implemented job placement and recruitment system invention further allow employer/Client subscriber users with an urgent and immediate need to fill a shift, to send a Priority Invitation Message to their connected employees who possess the required job skill, however do not have current availability. The Priority Invitation Message alerts employees to this last minute opportunity they would otherwise have been unaware of.

Process:
1. Employer inputs requirements for the shift they have a need to fill (skill, shift start/end time, location, rate).
2. The system platform searches for employees from within the users current connections that meet all requirements.
3. No employees are returned in the search results, as no connected employees meet all requirements.
4. However, as part of the search algorithm, the mobile device implemented job placement and recruitment system identifies employees that meet all requirements, with the exception being those identified employees whom do not have current availability.
5. Users are given the option to send a Priority Invitation Message to this group of employees without current availability that were returned by the search.

A User proceeds to either send a Priority Invitation Message to connected employees without current availability, or they may choose to skip this option, deciding instead to make the job “public”. Extending the job to “public” ensures a far greater number of the invention users are included in the subsequent search, outside of their current connections.

Extending the use of the Priority Invitation feature as described, to the scenario whereby an employee who is no longer able to work a confirmed and scheduled shift, the responsibility falls on the Employee to find a skilled and available replacement to work their shift, thereby ensuring the Employer is not impacted. This will require the employee to use the Priority Invitation Message feature to identify, select and confirm their replacement. This feature is user permission-controlled, to accommodate the individual needs of each business.

Privacy Settings. Functionality restricting the viewing of a user's specific Availability and Skill details to their current connections only.

Process:
1. User A activates the Privacy Setting by selecting the “Only allow my connections to see my details” checkbox.
2. User B who is not currently connected to User A, locates User A in a system platform search result.
3. User B selects User A, and proceeds to view User A's profile.
4. User B is not able to view User A's Skill or Availability details.
5. User B is able to view the following User A details:
Member since month/year
Number of Recommendations
City/State/Country/Post Code, (if details are populated).

Get Started Guide

Functionality that steps a user through the primary system workflows, providing prompts along the way that allows users to complete any pre-requisites needed. The guide is presented to the user on initial registration. Subsequently, a user can revisit the guide by navigating to a menu option.

The guide covers the four main workflows:
1. Hire someone for a shift or job
2. Get found for a shift or job
3. Create a business account
4. Add connections to your network.

Pending Connections

Process:
1. User A requests to connect with User B
2. User A will have this connection request appearing under their Pending Connection Request List and User B will have this request appearing under their New Connection Request List.
3. If User B accepts the connection request from User A, the entry disappears from both lists, as User A and User B are now connected.
4. If User B ignores the connection request, this entry will still appear under User A's Pending List.
5. If User A cancels the connection request whilst it is still in the pending status, the connection request will be removed from User B's New connection Requests List.

Invitation to Download with Connection Request

Functionality of the mobile device implemented job placement and recruitment system allows a new user who receives an invitation to download and install the mobile device implemented job placement and recruitment system from an existing user, to automatically receive a system-initiated new connection request for action from that user on successful registration.

Process:
1. User A sends an SMS and/or Email to a new user (User B) inviting them to download and install the mobile device implemented job placement and recruitment system of the present invention.
2. User B receives invitation, visits appropriate store (App Store or Play Store).
3. User B downloads and installs the mobile device implemented job placement and recruitment system onto the user's mobile device.
4. User B completes the mobile device implemented job placement and recruitment system User Registration process.
5. User B is automatically alerted by the mobile device implemented job placement and recruitment system of a New Connection Request from User A (system initiated)
6. User B accepts Connection Request from User A.
7. User A and User B are now connected on the mobile device implemented job placement and recruitment system.

When an existing system platform user, (User A) sends the invitation SMS and/or Email out to a user not currently on the mobile device implemented job placement and recruitment system, (User B), the system captures and stores User A's unique identifying information, along with the Mobile Number and/or Email address they sent it to, (belonging to User B).

When User B, registers using the same Mobile Number and/or Email Address, the system performs a match and triggers the creation of the connection request that User B will receive after they login to OpenSimSim, (User B has the option to “Accept” or “Ignore” the connection request).

Having the mobile device implemented job placement and recruitment system automatically create the Connection Request from User A to User B, eliminates the need for User A to manually initiate and send a Connection Request to User B, after first needing to confirm with User B that they have successfully installed the mobile device implemented job placement and recruitment system.

User Permissions

Functionality allows mobile device implemented job placement and recruitment system users to be assigned pre-defined permissions and access, based on their individual role and responsibility within a particular Business. This feature provides centralized management and control of permissions on an “as needed” basis.

By way of example, the following are illustrative:

Tier 1—Full permissions to all features and functionality within the mobile device implemented job placement and recruitment system. This Tier is considered a “Super User”, typically assigned to the Business Owner.

Tier 2—Comprehensive permissions to the majority of features and functionality within the mobile device implemented job placement and recruitment system. This Tier is considered an “Administrator User”, typically assigned to a person who fills in for the Business Owner, a.k.a “2IC—Second in Charge” within the Business.

Tier 3—Selected permissions to all features and functionality allowing the user to perform their duties within the mobile device implemented job placement and recruitment system. This Tier is considered an “Operational User”, typically assigned to a person who fills a Shift Supervisor role within the Business.

Language translator: the invention will automatically use the language setting setup on a users mobile phone or computer. When receiving communication from the mobile device implemented job placement and recruitment system, users can determine what language they would like read the message in. Example—I am a manager of a restaurant and I send an invite to 5 users, “My language” is set to English so the invite goes out in English. However, 2 invitees may not be proficient in English so they can select to read the message in Spanish. And vice versa, an employee setting may be in Spanish but the manager may want to read the responses in English. It allows us to cater for multi language while allowing for multi language conversations ensuring everyone benefits from their native language when reading messages from someone who native language is different.

Monthly features further include:

“Who's viewed your profile”, “Jobs you may be interested in”, “Jobs you missed”, “User will appear higher in search results”, “n app reminders for upcoming jobs”, “Upload resumes”.

Users can purchase Priority Invitation Credit Bundles to add a Credit Protection plan for a monthly fee. Credit Protection—If a user or business sends a priority invitation message and no one applies to the invitation, the user will retain the credit. So when using a credit to send a Priority Invitation Message−No response=No Fee.

Poke feature to update availability for employment or job and/or shift availability.

The system application also enable subscriber users to utilize a scheduling module wherein each job within the schedule will appear on the user's “Jobs” page as a job the user is scheduled for without the need for any further approvals from other subscriber users.

Steps:

Users enter their standard Availability via a template. Additionally users can enter one off or on-demand availability which is different than their standard availability template (i.e. next Friday I am available for babysitting from 7-11 pm.)

Employer logs into OSS using their personal account. Employer switches to their business profile. Employer clicks on a new button called “Schedules”. Under the Schedules page, the employer sees a calendar view (daily/weekly view) in a spreadsheet format with each employee's availability and schedule. Employer has the ability to include as many of their connections into the calendar however the Employer has to request access from the employee in order to manage their schedule. Employer is able to manage the job schedule for an employee by posting new jobs for an employee or editing existing jobs that relate to the employer. If an employee is scheduled by another business or doing a job for another user, these slots appear as “unavailable” on the calendar view. Once the employer posts a job for an employee, the job appears on the employee's account under the Jobs page and they are notified through email/push notifications. Employer can take another weeks schedule from the past and copy to a future week/s, and refine/edit from there.

The scheduling module will provide the employer with the total number of hours their employees work per day and per week assisting with overtime issues. The scheduling module will also provide a 3 dimensional layer for the professional/client type relationships. An employer can schedule their employees for a specific time and assign the employee to a client (who can be on the OSS Platform and be a connection). Personal trainer works for One Fitness. One Fitness can see all their employees open availability and schedule them while assigning to a time slot and a specific client (who can be a connection). The personal trainer will see the job including the client details in their Job Page. Clients can view and request to book their connections availability. Once accepted, these jobs will also appear in the Personal Trainers Job Page against the client's name.

The benefits for the scheduling module are as follows:
Easy way to schedule employees and professionals by their employer
Creates adoption by all employees to be on the OSS platform with an easy way for current and future employers to find employees with specific skills and availability
Easy way for employees to be found by other employers enabling the employees to have additional work shifts with their existing employers (connections) or new employers
Easy way to clients to view future availability of professionals that are their existing connection and book an appointment
Easy way for clients to search for, find, view availability and book for service providers that they are not connected to because Professionals are on the OSS system utilizing the scheduling module.
Easy way for professionals to view empty slots in their future schedule and promote discounts to existing client connections to incentivize them to schedule during slow time periods.

The system application further enables a subscriber user to expand on their user profile by uploading an introductory video clip describing their respective skills, experience or other qualifications. Employer/Client subscriber users can provide more details on a job description, add questions to their profile that an employee/professional subscriber user can answer and also record a video message that potential employee/professional subscriber users can view prior to applying for the available employment position.

When searching for employees or professionals, the system application will create a % matching rate based on availability and return the percentage in the search results, eg: looking for 9-5 pm, OSS found 1 user who has availability for 9-5 pm so it will show that user with a 100% match. It may have also found 3 users who have availability for 9-4 pm so it will show those users with a 90% match, etc. This will allow employers or clients to send a schedule request for a period other than what is in the employees or professional's availability template.

The system application will further provide a map function that shows users all other employers based on their specific search criteria (location, type of employer, type of skills etc.) around their vicinity and the user can “like” the employer or send a connection request. When employers are recruiting new staff the system platform and software will show the number of likes for candidates who like their business.

Scheduling Modules of the system platform will operate in 2- and 3-dimensions according to the following examples related to work place schedules as well as fitness trainer schedules. The examples provided are not intended to be fully comprehensive of the full capability and applicability to the professional and social schedules of individuals but rather is merely intended to demonstrate a single example of the system application's operability and functionality.

2D Scheduling Module

The Corner Pub

| | | | | | | | |
|---|---|---|---|---|---|---|---|
| Mon | Tue | Wed | Thu | Fri | Sat | Sun | Total |

| | | | | | | | |
|---|---|---|---|---|---|---|---|
| Jack | | 4p-9p | | 2p-8p | | 1p-8p | 18.0 |
| Hours | | | | | | | |
| | Server | | Server | | Server | | |
| | (5.0) | | (6.0) | | (7.0) | | |
| Christie | | 4p-9p | | | 11a-5p | 11.0 Hours | |
| | | Server | | | Server | | |
| | | (5.0) | | | (6.0) | | |
| James | | 4p-9p | | 2p-8p | | 1p-8p | 18.0 |
| Hours | | | | | | | |
| | Bartender | | Bartender | | Bartender | | |
| | (5.0) | | (6.0) | | (7.0) | | |

Your Fitness Place

| | | | | | | |
|---|---|---|---|---|---|---|
| Sun | Mon | Tue | Wed | Thu | Fri | Sat |

| | | |
|---|---|---|
| Jack | 6a-7a | 6a-7a |
| | Trainer | Trainer |
| | Olivia | Bruce |
| | 8:30a-9:15a | 7a-7:30a |
| | Trainer | Trainer |
| | Roger | Kevin |
| | 11a-11:30a | |
| | Trainer | |
| | Kate | |
| Christie | 8a-9a | |
| | Massage | |
| | Holly | |
| | 9:30a-10:30a | |
| | Massage | |
| | Sarah | |
| James | 6a-6:30a | |
| | Trainer | |
| | Harold | |
| | 6:30a-7:30a | |
| | Trainer | |
| | Mike | |

This scheduling module is part of the system platform software capability and enables subscriber users the following capabilities:

Enables the employees to see their schedule for the day or for the week as it is posted. Enables the employees to swap or give away their shifts to another employee if the employer has approved this process. Enables the employees to show current and future employers when they are not working hence when they may be available to work. Enables the current employers a tool to show them how many hours someone is working for the day/week so that they can avoid accidental overtime hours by selecting an employee who would go into overtime over an employee who hasn't worked enough hours yet. Enables the employers to ensure that all their employees have a high degree of employee adoption of the system platform, which in turn will enable the employees to be visible to other employers for additional work aiding retention.

With regard to scheduling capabilities of the system application, a 3-dimensional scheduling capability is also provided and described with the following example. The example provided is not intended to be fully comprehensive of the full capability and applicability to the professional and social schedules of individuals but rather is merely intended to demonstrate a single example of the system application's operability and functionality.

3D Scheduling Module

The 3D scheduling module adds another dimension to the 2D scheduling module. The additional dimension is the client for whom the service or work is being done. In the example above James is working at Your Fitness from 6 am to 6:30 am with Harold. This concept helps the business manager easily see the appointments or bookings that his/her business has for all the service providers showing availability and busy times. Specifically this scheduling module being part of system and communications platform does the following:

Enable the business manager to book an appointment for a service provider. Example: A customer calls or walks in and wants service. The business manager can easily see who is available, the desired time to provide the service and enters that appointment or booking into system platform. This communicates to the service provider that they are providing this service at the respective time and shows them as busy for that time period.

Enable an existing customer to book an appointment. Example: An existing customer who is connected to James can view James' availability on the system platform or App and find and book a suitable time. This alleviates the back and forth communications that sometimes takes place between the two parties to find a suitable time.

Enable a new customer to search, find and book an appointment. Example: Someone who is not an existing client can search for and find service providers in their geographic area. The client can then make a choice based on existing ratings and the desired availability and book an appointment for the service.

Enable the business manager or the service provider to offer discounts alerts to fill appointments during slow periods to existing and new customers. Example: The business manager or service provider notices that they have no bookings or appointments the following Wednesday afternoon. They can elect to send a notification to their existing clients of the openings along with a note that if they choose to book during those specific times they are going to pay discounted rate (e.g. 30% off).

The system application further enables subscriber users to search for service providers such as for example business establishments that employ user of the system application in order to connect their respective employees and so that users can request services or for example, request a reservation. This allows users to search for a business, send a request to the business with the business replying with a confirmation that such services can be provided. The confirmation booking will appear in the user's booking menu.

The system app also enables employees to remain self employed or are employed by the employer directly. Other prior art describes employees whom are employed by a web-based company wherein the web-based company is acting as nothing more than a placement employer. In the present invention, employees are hired directly by the employers posting the position. Such a configuration allows for corporate oversight of all employees conducting business on behalf of the employer. It also adds clarity to the tax considerations of employers who engage and retain employees on a temporary/permanent basis.

In other words, the system app of the invention enable employers to hire employees to fill immediate needs directly without the need of third party involvement. Direct hiring of employees/professional by employers/clients is accomplished by establishment of network connections wherein individuals are in direct contact with one another whom contact one another to fill immediate and future employment needs based on geographic and time sensitive considerations.

Likewise, Professionals are individuals whom establish network connections with other subscriber users that seek the services of Professionals either on an immediate or future time, and either on a permanent or temporary (i.e., one or two shifts) basis. The retention or hiring of Professionals by subscriber users is done directly via the system app with subscriber users employing use of the system app to outline availabilities, geographic locations, ETA information, experience, job requirements, available shifts and length of employment. Importantly, Professionals are hired directly by employing subscriber users via use of the system app.

Clients as understood in the present invention are those subscriber users that seek the services of other subscriber users (e.g., Professionals) to fulfill the needs of the Client. Again, Clients post for example, job requirements, geographic needs, available opportunities, pay rate for opportunity and length of employment wherein the Client hires the Professional subscriber user directly via the system app.

The system application also allows a subscriber user to gather professional recommendations that are posted to the user's account profile following each successful completed transaction wherein the user is able to add recommendations to their respective accounts for future viewing by other subscriber users. In such circumstances, in order to ensure reliability of recommendations, it is contemplated that only those subscriber users whom have engaged in Employer/Employee or Professional/Client relationships will be able to recommend or endorse the other respective party subscriber user. Moreover, the social media aspect of the system app claimed herein encourages the establishment of network connections on a perpetual basis without any involvement whatsoever with a third party web-based provider. All Employer/Employee and Professional/Client relationships are established directly between the respective subscriber users involved.

As with Facebook® and other social media web sites of the like, the social media aspects of the system app allow for exponential growth of the working and employment relationships that are established, yielding a nearly unlimited potential for a quick and efficient employee work base by establishing available real time network connections. In essence, the more network connection a subscriber user has within their network, the greater the potential to fill available job positions and likewise, the greater likelihood that subscriber user's seeking employment will be able to secure such employment using the system application. Since the system app is a mobile based device, as well as web-based, employment opportunities, such as shifts and/or opportunities that suddenly become open in the course of a working day, can be filled nearly immediately by simply accessing a mobile device, activating the system app and searching for qualified and available employees whom are within a desirable geographic location so to fill the immediate need directly.

Furthermore, the system allows a subscriber user to set up multiple profiles for various purposes. For example, a subscriber user can set up an “employee” profile that they will employ and “push” to employers in attempts at securing a position posted by an employer. Simultaneously, the same subscriber user can set up an “employer” profile, the profile detailing the subscriber user's business information and background, and also highlighting the job opportunity that subscriber user has posted at the time. The system also allows a subscriber user to set up a “business” profile to which the subscriber user can be set up as an “Administrator” of the business being profiled.

As described herein, the invention, initially, will provide subscriber users with an unlimited number of push notifications in order to establish connections and engage in business matters pertaining to the system application. After a specified period of time, the number of push notifications will be limited depending on whether a particular subscriber user provides payment information to acquire additional features including but not limited to push notifications beyond the number already provided by the system application.

As envisioned herein, the subscriber user's reputation and recommendations by prior employers, employees, professionals and clients will also be visible to the user's network connections. Those statuses can also be pushed to such network connections as well as to those subscriber users that may be outside the network of the subscriber user. Subscriber users who are seeking to fill an available permanent or temporary position will also be able to search other subscriber users by employing the use of a filter that analyzes qualifications, past work history as well as reputation and recommendations of the subscriber user being considered for employment. Likewise, employee subscriber users seeking employment opportunities can employ a filter of the system that narrows search criteria to job types, industry, reputation and “recommendations” associated with the employer/client and other attributes of the employer/client. The search engine and filter will also act automatically to generate search results that are pertinent and which relate to the subscriber user's needs.

Accordingly, the system claimed herein allows a subscriber user to tailor their search and search criteria manually, and will also provide a system that retrieves search results based on an automatic computer analysis that is based on the subscriber user's profile information and job posting criteria and requirements. Significantly, a preferred embodiment of the invention is that the system allows a subscriber user to engage other subscriber users on a more personal and interactive level than has been previously allowed in the prior art. Hence, the social media aspect of the system is a critical aspect of the invention. The system described herein allows a subscriber user the ability to act proactively, as well as in an automated fashion, in engaging suitable network connections in establishing online and non-online business relationships with individuals with whom the subscriber user can seek employment opportunities either currently or at some point in the future, all in a convenient mobile device implemented system.

In a preferred embodiment, search results generated by the system allow the subscriber user to push their current availability to other subscriber users seeking to fill temporary or permanent positions. Likewise, as the system allows for proactive and real time interactions with colleagues, network connections and non-network connections, and does so by pushing availabilities and posted job postings to potentially interested subscriber users. Proactive interaction however, also includes the ability of network subscribers to engage in online chat sessions, in real time, including the ability to set up video chats in real time, with chat sessions being capable of being conducted via mobile device from any location.

The system application further allows a subscriber user the ability for real time push notification of availability for an employee and/or professional. For example, a subscriber user can be an employee subscriber user and can push out their availability changes in real time. In addition, as a professional subscriber user, the user can push out their availability for jobs in real time. For instance, the user may have a cancellation and want to update other subscriber users with the new availability.

The system application also provides a calendar function wherein once a subscriber user has accepted one or more jobs, the system application synchronizes the details of the job shift or position to the subscriber user's calendar and calendar of choice. In a preferred embodiment of this element, once a shift and/or job has been accepted, the system app will upload the details of the shift and/or job to the users calendar on their device (Gmail®, Outlook®, Yahoo®, etc.)

The mobile device implemented job placement and recruitment system also provides subscriber users with a Reminder function wherein a subscriber user can set a reminder for future job and/or shifts within the system application “app”. Reminders can be set for all accepted jobs and/or shifts. The reminders appear in the form of a pop-up or a status bar notification and can be set for any length of time before the job and/or shift with the system app allowing the subscriber user to set more than one reminder if necessary for multiple accepted jobs. A subscriber user can also turn off the reminder feature through their system application “app” settings.

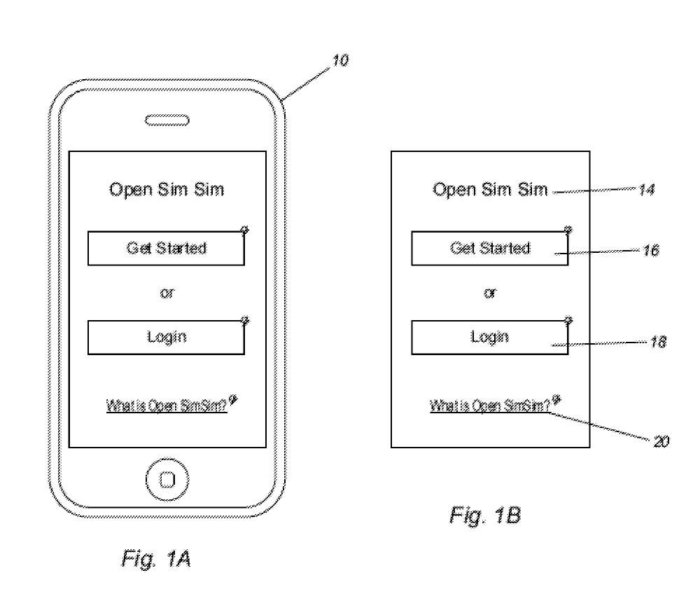

Turning now to the substance of FIGS. 1 to 29 and the preferred embodiments of the invention. FIGS. 1A and 1B provide a rendering of the initial electronic page of the app invention as it is displayed on a mobile device 10. The illustrations as described herein and below include a user's perspective of the view on a mobile device as displayed on the left side of each of the Figures, and also provides the electronic page in its entirety, which may not be viewable in its entirety on a mobile device due to the small size of the mobile device display. In such cases, a user can scroll down the electronic page on the mobile device or website in order to view the entire page.

As shown in FIG. 1B, the initial electronic page provides the app name/title 14, in this case for example, is “OpenSimSim” but such title is not limited in the present application. In employing use of the app for the first time, an individual selects and presses the “Get Started” digital button 16 in which a prospective subscriber will register to become a member of the system application or in the instance in which the individual is already a subscriber user; they will select the “login” digital button 18. Another functionality allows users to review the operability of the app by selecting the “What is OpenSimSim?” digital button which takes the subscriber user to an instructional video 20.

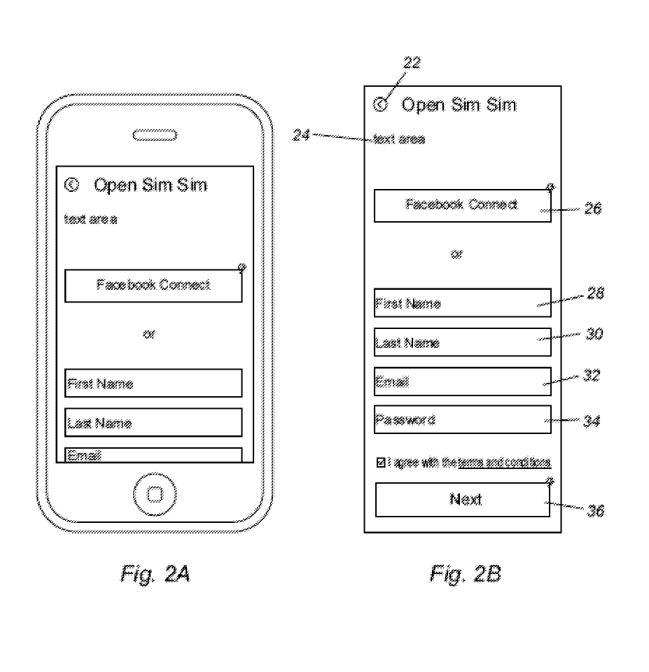

FIGS. 2A and 2B illustrate a preferred embodiment of a login digital page. In particular, the illustrations provide elements of the login page wherein a subscriber user can enter text 22 associated with their account, enter first and last name 28, 30 as well as email address 32 and password 34 information in order to access their account. In addition, a user can login and/or register using their Facebook® credentials. Once the information is entered, the subscriber selects the “Next” button to advance through the process of accessing and editing their account information.

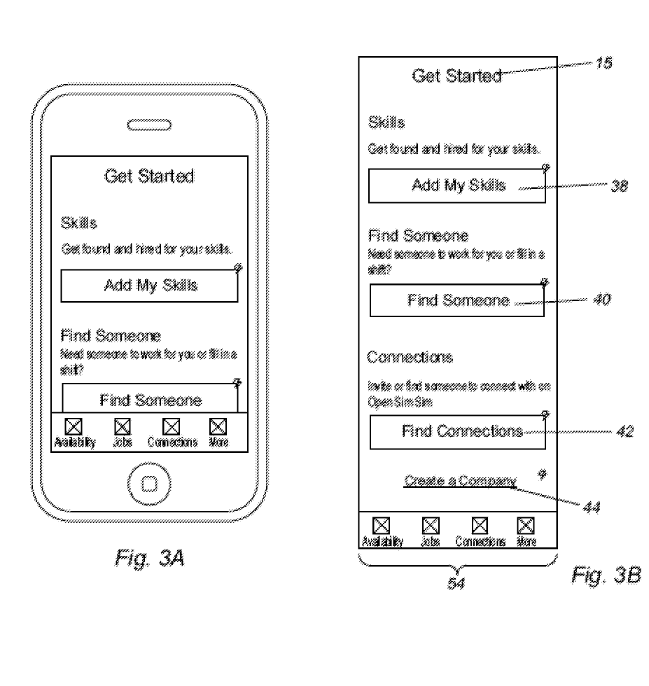

FIGS. 3A and 3B illustrate a preferred embodiment of an electronic page of the invention wherein a subscriber user can access additional pages in which to add skills 38 and to search for a skill within a location between a date and time range from their connections or anyone registered with the system app 40 or even search for connections and/or invite connections via email or cell phone whom are not associated as a subscriber user 42. The page also enables a subscriber user to create and edit information associated with a particular company that is seeking qualified employees/clients for available work shifts or looking for services 44. Also provided are shortcut buttons 54 that a subscriber user accesses to forego advancing through unnecessary pages.

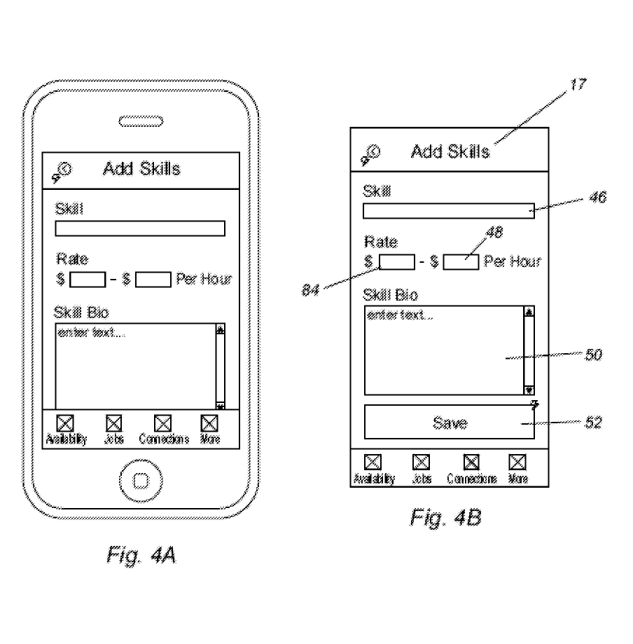

FIGS. 4A and 4B illustrate a preferred embodiment of an electronic page 17 of the invention wherein a subscriber user enters and saves skills 52, experience 46, 50 and hourly pay rate sought 84, 48. As envisioned, elements herein are not limited by the illustrations provided and other information can be incorporated into each of the electronic pages described.

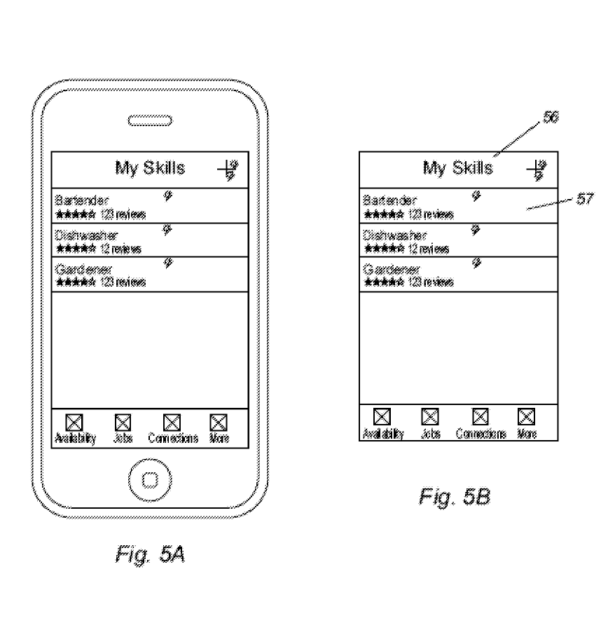

FIGS. 5A and 5B illustrate a subscriber user's account profile page subsequent to the user entering prior work history information into their account. Specifically, the subscriber user enters information into the “My Skills” page 56 pertinent to their prior work history and experience. Thereafter, each of the user's previous work positions is displayed in a listing 57 that is viewable to other subscriber users with whom there is an established network connection.

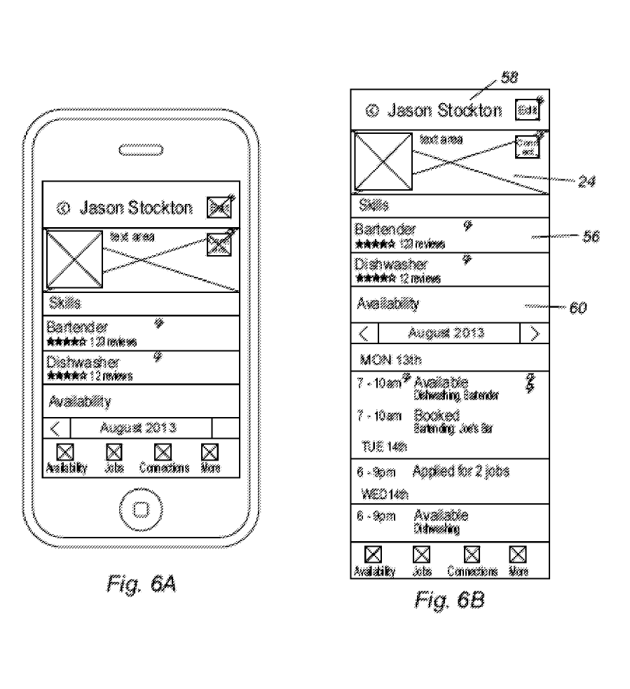

FIGS. 6A and 6B illustrate a preferred embodiment of the subscriber user profile electronic page associated with a subscriber user's account including but not limited to name 58, picture and bio 24, skills 56, recommendations 56 and availability profile 60. Specifically, as illustrated, a subscriber user can enter text 24 associated with skills and job opportunities listed on the page including but not limited to the users availability by skill, time of day, day of week. Booked jobs/shifts with skill, location and jobs/shifts applied for 56 and 60 and availability for the skills listed 60.

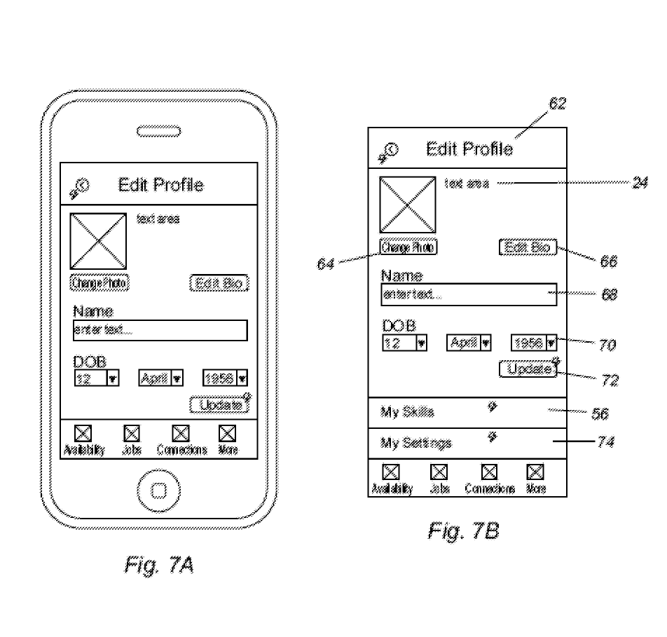

FIGS. 7A and 7B illustrate elements of an electronic page of the invention wherein a subscriber user will edit 62 their profile account. Specifically, a subscriber user can enter general text 24, upload a profile picture 64 and edit biographic and professional information 66. The subscriber can also enter name 68, date of birth 70 and update the profile 72 as necessary. The subscriber user can also access other electronic pages related to their profile for example, the “My Skills” 56 and “My Settings” 74 pages can be accessed among others.

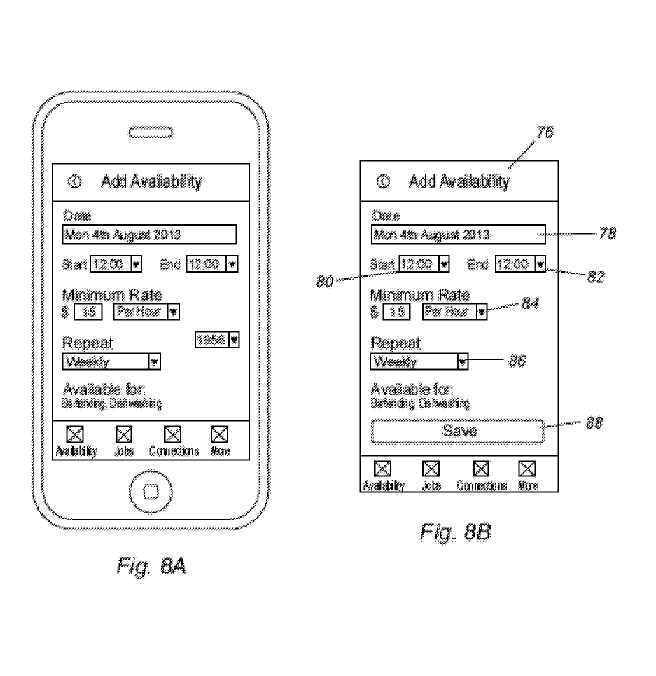

FIGS. 8A and 8B illustrate yet another preferred embodiment electronic page 76 of the invention. Specifically, the page illustrated allows subscriber users to add/edit their general availability by skill for taking on new job opportunities. For example, a subscriber user can enter the date 78, the start and ending times 80, 82, a minimum pay rate 84 and the daily, weekly, fortnightly or monthly level 86 of availability related to their ability to take on new jobs. After entering the data, the user can save 88 the information for viewing by other network connections.

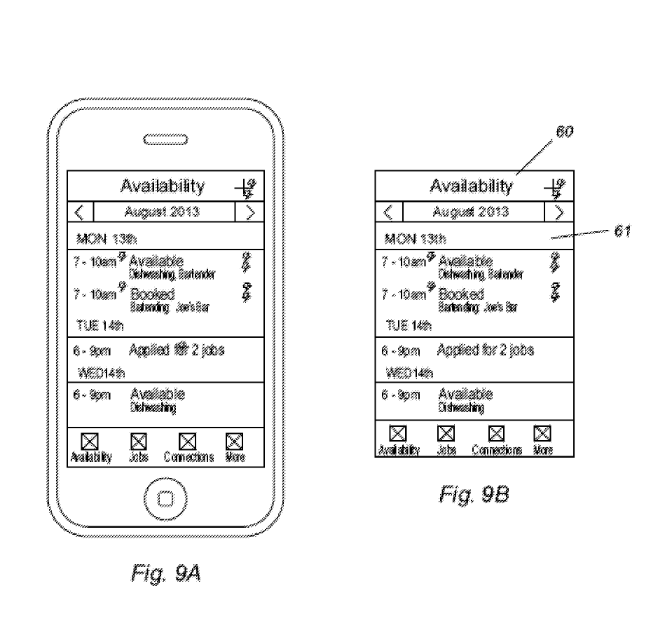

FIGS. 9A and 9B illustrate a preferred electronic page embodiment of the invention wherein a subscriber user can add more availability information for viewing by potential employers. Specifically, the illustration provides the subscriber user the ability to enter specific dates and times by skill 61 on the availability supplemental page 60 wherein the number of jobs applied for and other pertinent information are listed.

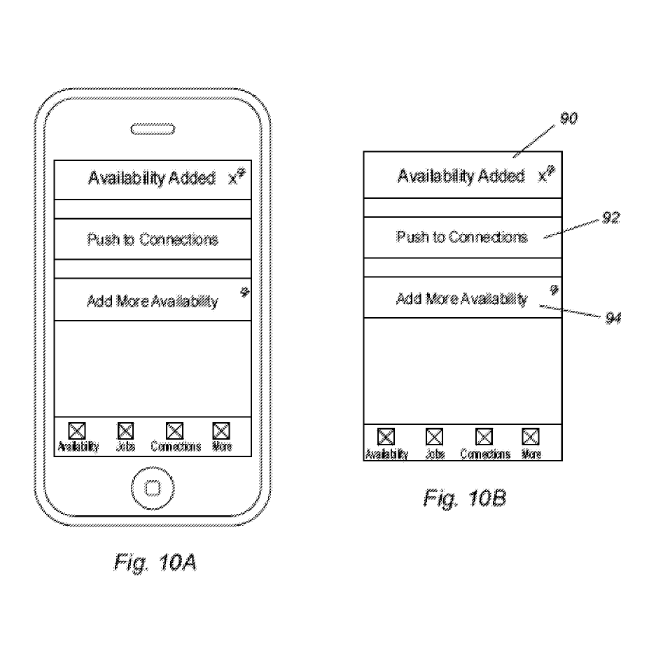

FIGS. 10A and 10B illustrate an electronic page of the invention wherein a subscriber user's availability 90 is listed and viewable by other subscriber users. Further illustrated is a button a subscriber user can select to push or forward 92 their availability to other subscriber users. The page further allows the subscriber user to add more availability 94 for other prospective job opportunities.

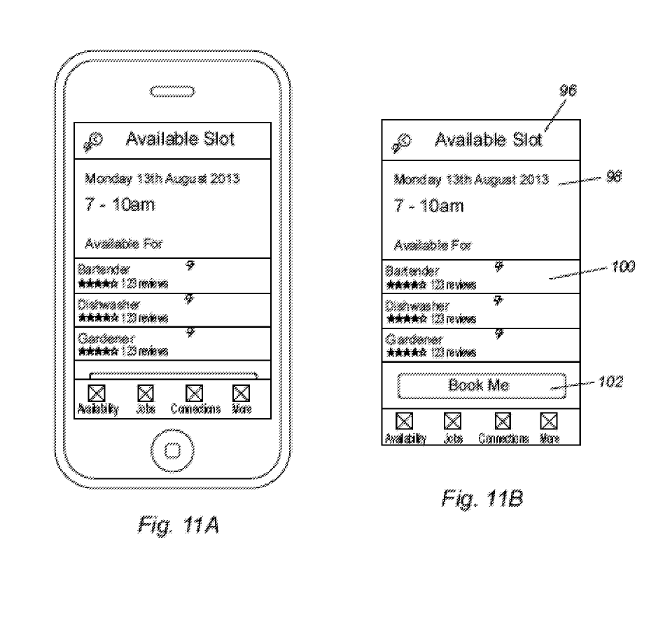

FIGS. 11A and 11B illustrate an electronic page of the invention wherein a subscriber user can book another subscriber user to occupy a job opportunity listed 96. As shown, the page allows a subscriber user to select a desired position 100 which will also highlight the date and time of the position 98. The page further allows a subscriber user to select a button, for example, the “Book Me” button shown 102, to hire the subscriber user of interest for the position.

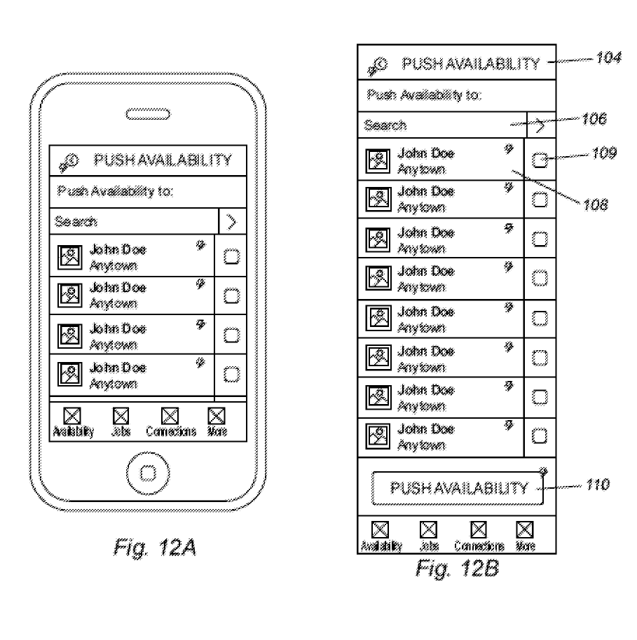

FIGS. 12A and 12B illustrate an electronic page 104 of the invention wherein a subscriber user can forward (i.e., “push”) their availability 110 for a particular job opportunity or time slot to other subscriber users 108, 109 that may have an interest in employing the subscriber user. The subscriber user can also conduct a search 106 of other subscriber users to whom they may forward or push their availability to in search of a position or job opportunity.

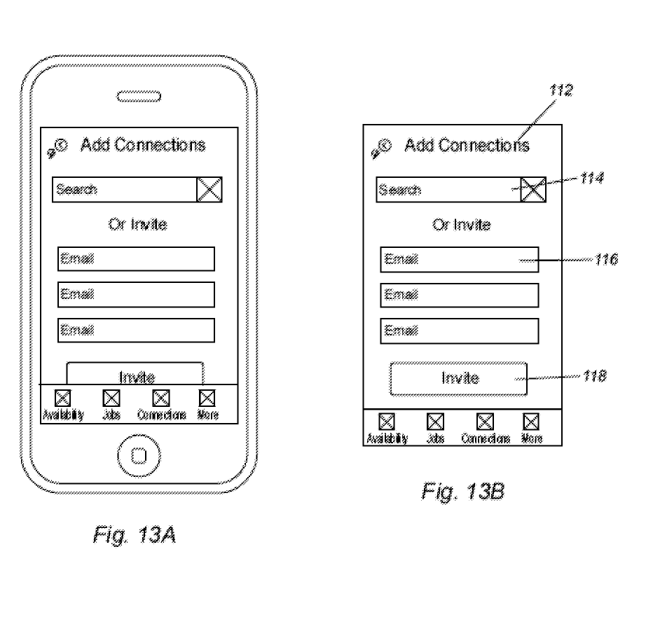

FIGS. 13A and 13B illustrate an electronic page on which a subscriber user is able to add new connections 112 to their existing list of network connections. As shown, a subscriber user can access their contacts list or search 114 for new network connections (i.e., other subscriber users) to whom the subscriber is interested in contacting to discuss current or future business or job opportunities. The page allows the subscriber user to enter email addresses 116 and push invitations to those email addresses 118 to establish connections.

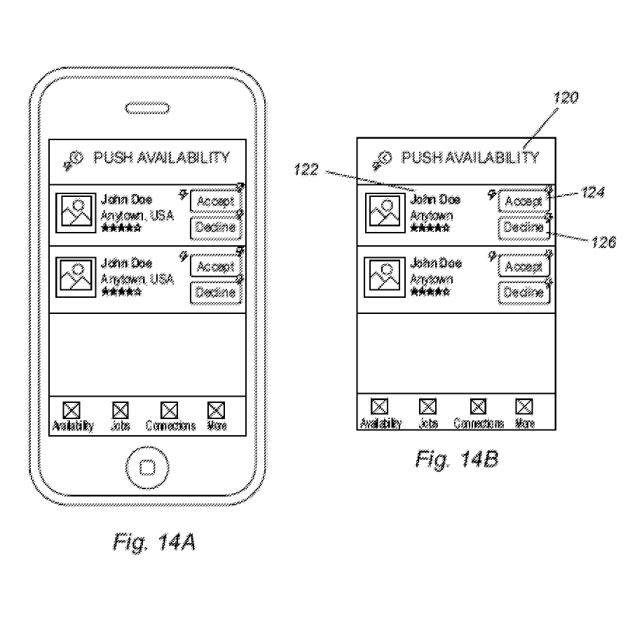

FIGS. 14A and 14B illustrate an electronic page of the invention wherein a subscriber user has received a connection request from a subscriber. As illustrated, the receiving subscriber user can view from whom the connection request was sent 122, and can select to either accept 124 or ignore 126 the connection request of the sender.

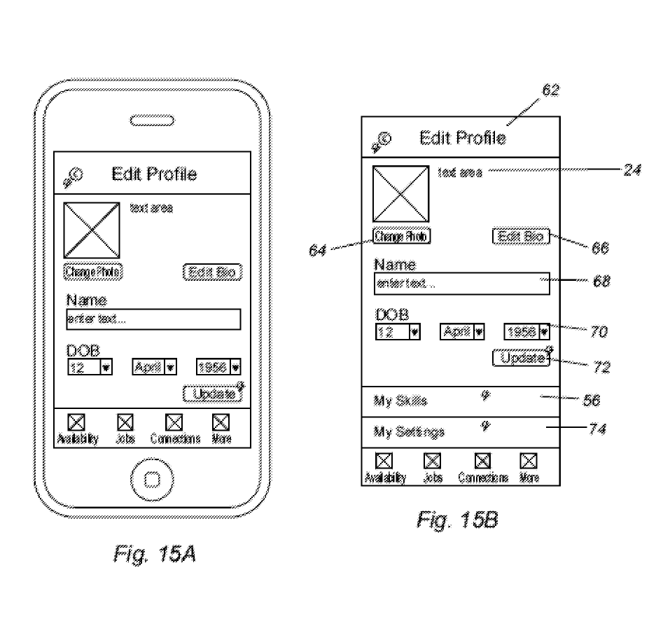

FIGS. 15A and 15B illustrate yet another preferred embodiment of an electronic page of the invention. As shown, the page allows a subscriber user to edit their account and profile 62 information by uploading a profile photograph 64, entering name information 68, date of birth information 70, and allowing the user to update the information as appropriate 72. The user is also able to edit their biographical information by selecting the “Edit Bio” 66 or other button has appropriate. Other pages are also accessible from this page as well including but not limited to the “My Skills” and “My Settings” pages 56, 74. The subscriber user can also add general text information 24 into their profile to distinguish their qualifications from other subscriber users.

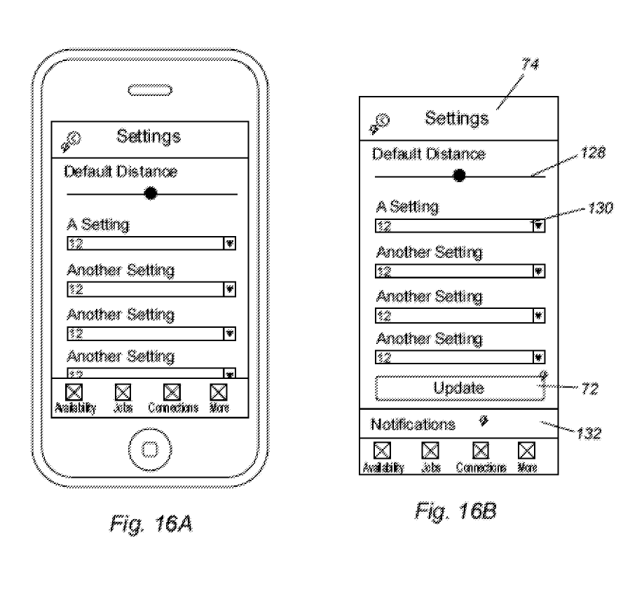

FIGS. 16A and 16B illustrate yet another preferred embodiment electronic page of the invention wherein a subscriber user can edit and add search criteria and filtering when either searching for job opportunities or in searching for qualified candidates to fill available job positions or shifts 74. For example, a subscriber user can limit the distance 128 in which they will travel to a job site or contrary wise, an employer subscriber/client user can limit the search for candidates to a certain specified distance from the work site. Other settings and search criteria 130 can be added as well and updated as appropriate 72. The subscriber user can also view notifications via email, SMS or pop up message including but not limited to availability that has been pushed to their account 132 by other subscriber users.

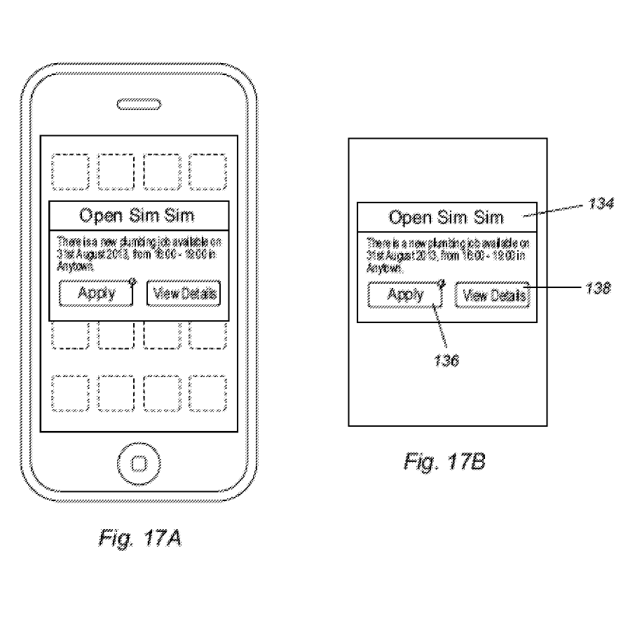

FIGS. 17A and 17B illustrate yet another preferred embodiment of an electronic page of the invention wherein a subscriber user is able to view a newly posted job opportunity via mobile device or online. More specifically, as shown, the page displays the “app” title, in this case, “Open Sim Sim” 134, and provides the subscriber user the opportunity to either select a button to view the details of the available position/job 138 or to select another button 136 to simply apply for the position/job.

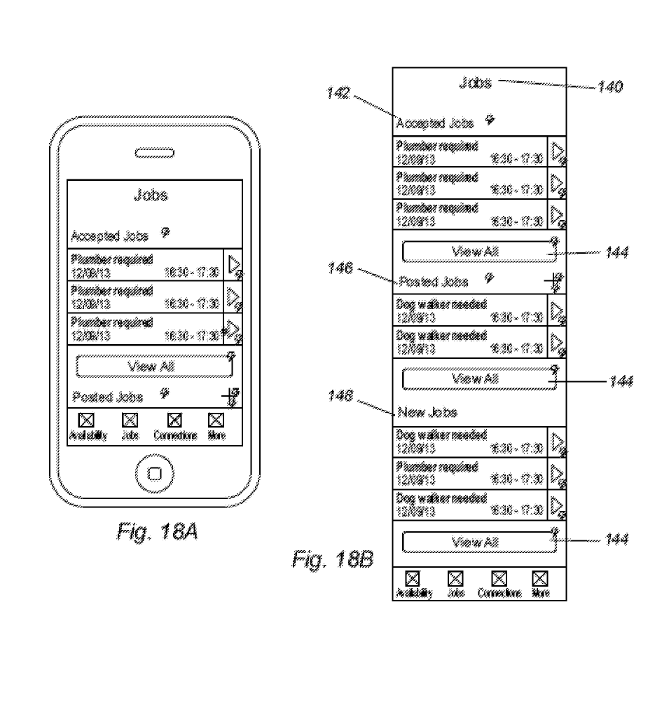

FIGS. 18A and 18B illustrate yet another embodiment of an electronic page of the invention that displays a variety of job opportunities 140 that relate to a particular subscriber user. For instance, the job listing illustrates work positions and/or opportunities that have been accepted 142, positions and/or opportunities that are generally posted 146, and newly posted positions and/opportunities 148, all of which apply to the subscriber user's background and professional qualifications. The subscriber user can also select the “View All” button 144 in order to see only the selected job positions he wishes to review.

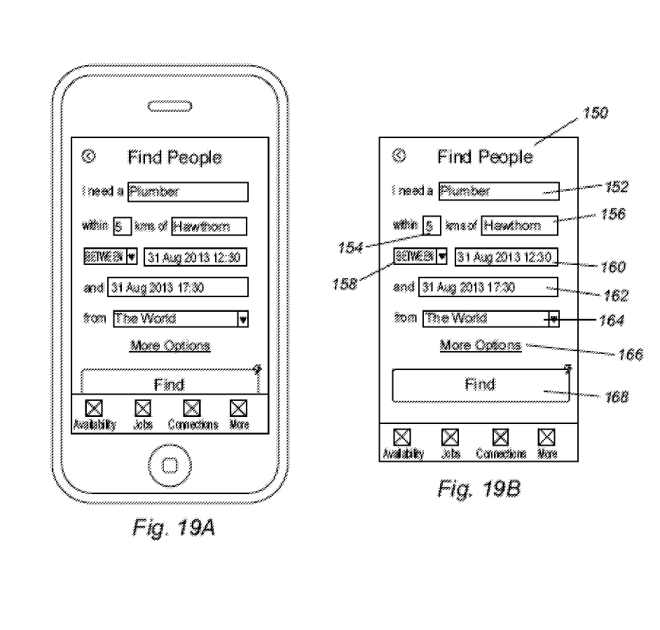

FIGS. 19A and 19B illustrate a version of a preferred embodiment of an electronic page of the invention wherein a subscriber user is able to search and locate 168 qualified employees/professionals for a job opportunity 150. More specifically, a subscriber user enters a desired job type or job position 152 while also specifying distance criteria 154, desired city or locale 156, beginning and ending dates of employment desired 160 as well as time of employment 160, 162. The subscriber user can conduct a search of qualified applicants including only connections, but may also search qualified candidates whom are not connections with the particular subscriber user and whom are other subscriber users 164. The app in this case therefore, allows employer subscriber users to search not only potential employees/professionals within their own network connections but also for employee/professional subscriber users whom are not part of the employer/client subscriber user's network connections. The illustration provides a preferred embodiment of the search page however, additional search filtering options 166 are also available and are within the scope of the invention.

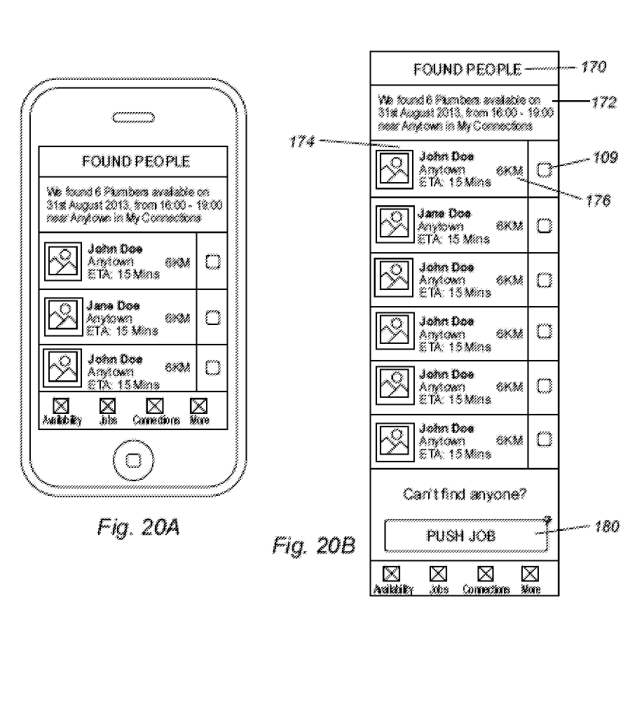

FIGS. 20A and 20B illustrate a preferred version of an electronic page of the invention as provided on a mobile device display. More specifically, the page 170 provides the results of the search conducted in FIGS. 19A and 19B. For example, the page displays the number of potential qualified candidates generated in the search 172 and also displays the name 174 and distance of the prospective candidate from the job site with estimated time of arrival 176. In the event the employer subscriber user has an interest in pursuing a particular job candidate further, they can select the candidate 109 and push the job position/opportunity to that candidate by selecting the “Push Job” button 180 on the display, whereupon the position is forwarded electronically to each of the desired job candidates.

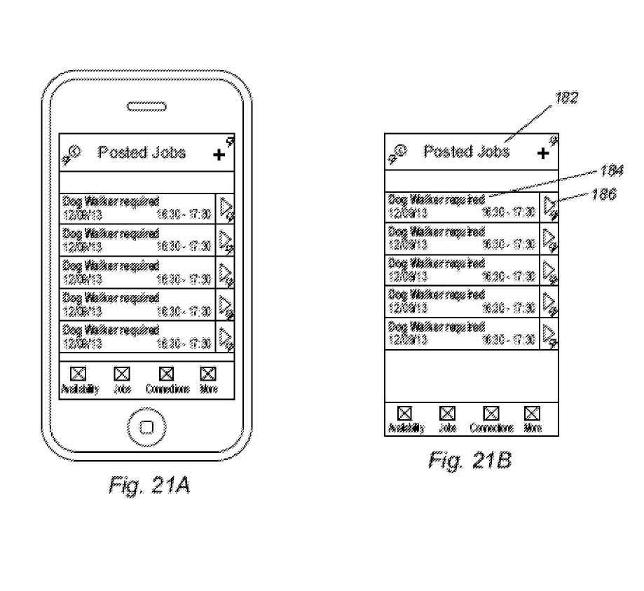

FIGS. 21A and 21B illustrate yet another preferred embodiment of the invention which displays posted positions/opportunities for viewing by a subscriber user 182. More specifically, the page displays the particular job position or opportunity 184 including date and time of the position/opportunity. In the event the subscriber user wishes to see additional details regarding the job position/opportunity, they can select the details button 186 which will display all details associated with the posted position/opportunity.

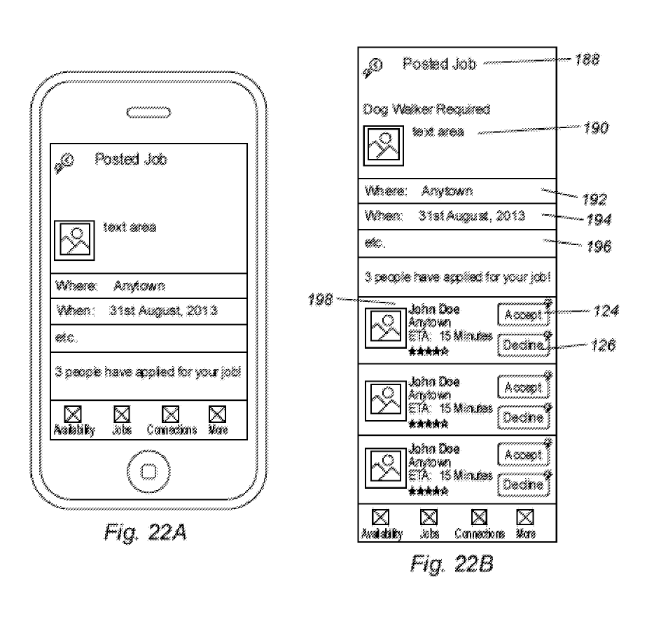

FIGS. 22A and 22B illustrate yet another preferred embodiment and version of an electronic page of the invention that displays posted jobs/opportunities 188. As shown, in the event an employer/client subscriber user receives notification that they have received interest from an employee/professional subscriber user for a new job posting, the employer/client subscriber user can view general text 190 associated with the job posting, its location 192, the dates required in order to work the job 194, the name of the employee/professional applying for the job, their location, their estimated time of arrival and their recommendations 198, and other miscellaneous information related to the position/opportunity 196. Further, the employer/client subscriber user can select either a button to accept the position 124 or ignore the position 126. The Figure also illustrates the name of the employee/professional subscriber user that is associated with the job posting 198.

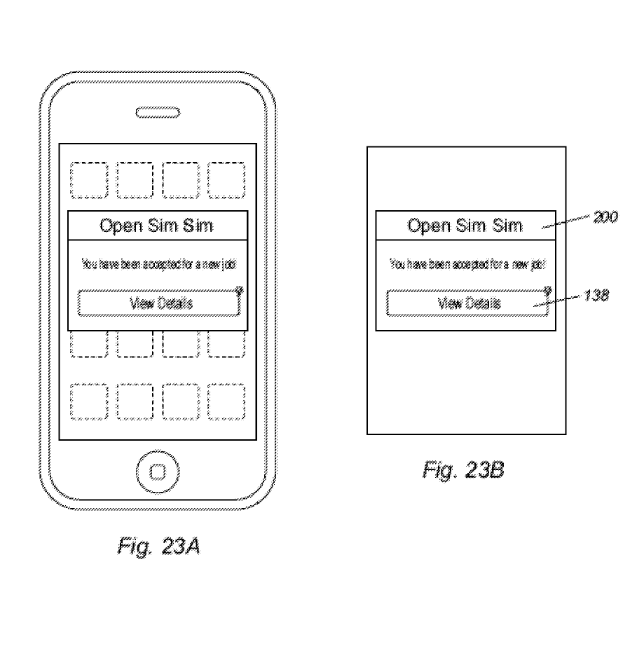

FIGS. 23A and 23B depict an electronic page of the invention as displayed on a mobile device. In particular, as shown, the page displays notification that an employee subscriber user has been selected to take on a position/opportunity that was previously posted by an employer/client subscriber user 200. The employee/professional subscriber user is also provided with a digital button that they can select in order to view and save details associated with the job position/opportunity 138.

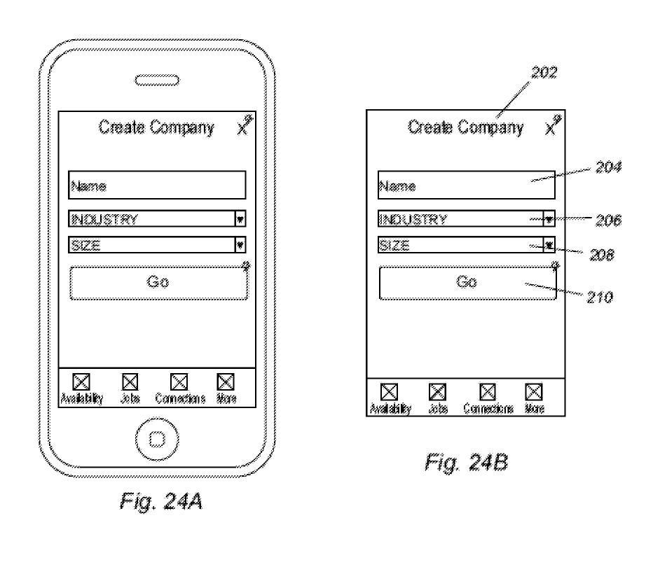

FIGS. 24A and 24B illustrate yet another preferred embodiment of an electronic page of the invention as displayed on a mobile device. Specifically, the display and page allows a subscriber user to create a new corporate entity 202 on their account, further allowing the user to include name of the business 204, the industry type 206 and size of the business (employee number range) 208. The subscriber user is able to save the business information by selecting a button 210 whereupon the entered information is saved and thereafter viewable by other subscriber users.

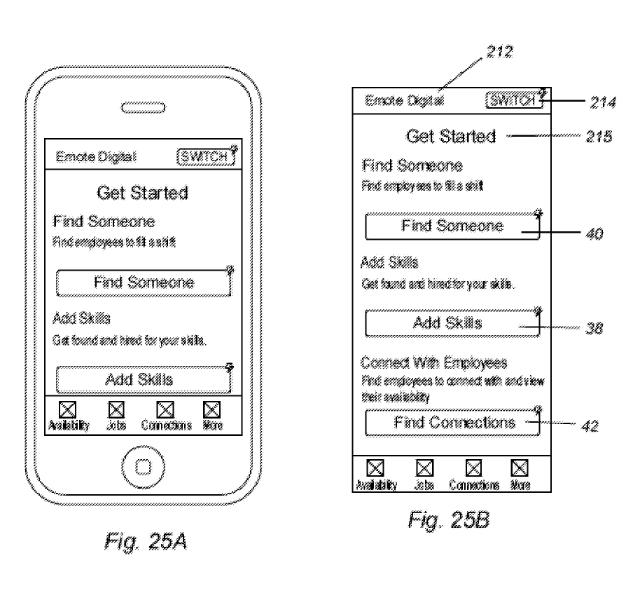

FIGS. 25A and 25B provide yet another preferred embodiment of the invention in which an employer/professional subscriber who is an administrator (representative of the business) 212 can search for employees/clients to fill an available position or job/service 215, 40. As shown, the display allows an employer/professional subscriber user to select a button in which they will add desired qualifications 38. Employer/professional subscriber users can input their skills 38, availability (i.e. this could be operating hours), post an available shift and/or post jobs 40 that need to be filled. Find and invite connections to the business network 42. Also illustrated is the system ability to display the business name 212 and provides the subscriber user the ability to select a switch 214 that allows the subscriber user to toggle between the subscriber user's personal/professional profile and the subscriber user's corporate profile.

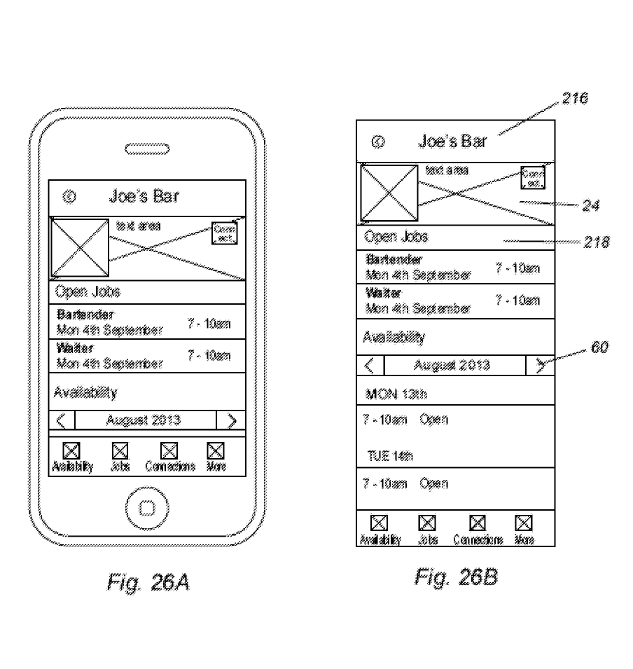

FIGS. 26A and 26B illustrate yet another embodiment of an electronic page of the invention that displays open positions and job opportunities posted and viewable by a employer/professional subscriber user who is an administrator (representative of the business) on a mobile device or internet 216. In the embodiment, the employer/professional subscriber user who is an administrator (representative of the business) can view general description and text associated with the job positions 24 as well as the availability of the jobs 218 including the dates and times of work. The employer/professional subscriber user who is an administrator (representative of the business) in this instance can scroll through different dates for the posted positions 60 in order to determine available jobs and/or shifts by skill, date and time that have been posted by the business. Employer/professional subscriber users who are administrators (representative of the business) can access the business availability screen, which provides a view of their employee's availability by skill, date and time.

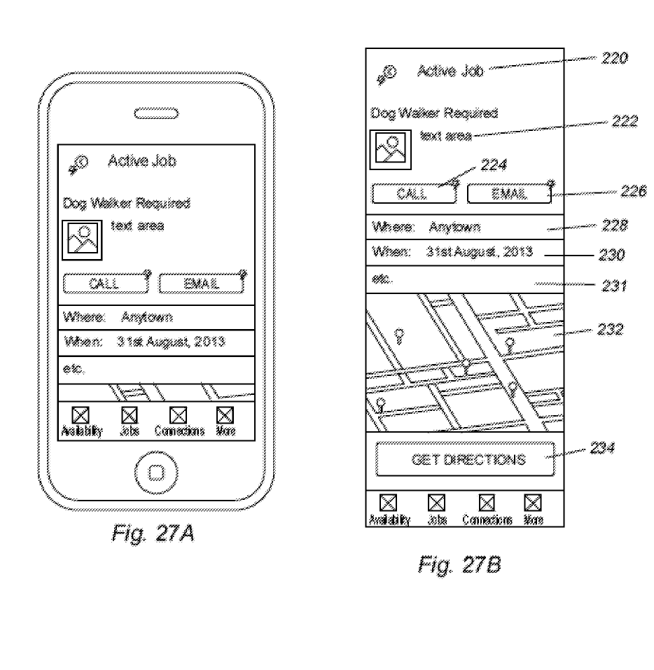

FIGS. 27A and 27B illustrate an electronic digital page display of information associated with a posted position/opportunity 220. As shown, the subscriber user is able to view general text information relating to the position/opportunity 222, the city in which the position/opportunity is located 228 and dates of employment 230. Additional job site information is also provided 231 as appropriate. On this page, the subscriber user can also call 224 or email 226 the employer/client subscriber user in order to learn more about the position if necessary. The page further provides a map 232 of the job site and selection of another button provides driving directions to the employee/professional subscriber user 234.

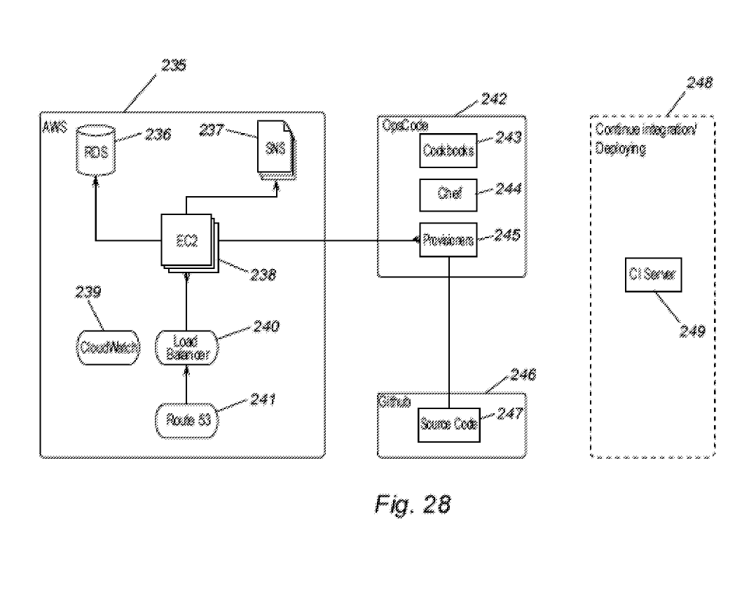

FIG. 28 depicts the hardware and software “backend” of the system application and invention claimed herein. In particular, the illustration provides 3 primary sections for backend hardware and software that include elements of the mobile device implemented system application. An Amazon Web Services environment (AWS) 235 is employed to host the system application in conjunction with an Amazon Relational Database Service (RDS) 236, Simple Notification Service (SNS) 237 to “push” notifications to subscriber users, an Amazon Elastic Compute Cloud (EC2) 238 provides resizable computing capacity in the AWS cloud. Cloud Watch 239 provides monitoring for AWS cloud resources and the applications subscriber users run on AWS.

A Load Balancer 240 (Amazon Elastic Load Balancing) distributes traffic across multiple EC2 in the AWS cloud. Amazon Route 53, 241, acts as the Domain Name System (DNS) web service in the AWS cloud. OpsCode 242 provides the Chef software configuration management tool. Cookbooks 243 is an application from OpsCode and is the fundamental unit of configuration and policy distribution defining a scenario, such as for example installation and configuration of MySQL and containing all of the components required to achieve the scenario. Chef 244 from OpsCode allows for deployment of the system application software to servers and applications to any physical, virtual or cloud location. Provisioners 245 take developed code and provisions across the AWS platform. Github 246 is employed as a web-based hosting service for software development of the system application. The source code 247 is a computer program written in a high-level language that is converted to object code or machine code by a compiler. Continue integration/deploying 248 describes the element of the system application to show the continued integration and deployment of the system application “app”. The CI Server 249 is a continuous integration server that is used to automatically build and test the system application at frequent intervals.

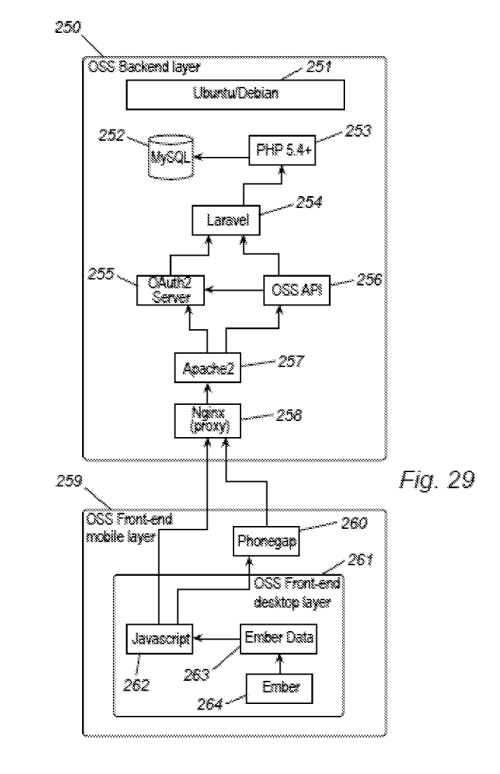

FIG. 29 depicts further preferred embodiments of the system application invention as they relate to the backend hardware/software components of the claimed system. The OSS backend layer 250 includes primarily the database store for application data. The Ubuntu/Debian 251 includes an operating system built to provide Linux server, desktop, phone and tablet operating systems. MySQL (Structure Query Language) 252 is an open-source relational database management system employed to store the system application data. PHP 5.4+ 253 is a server side scripting language designed for web development and used in the development of the system application. Laravel 254 is a PHP framework also used in the development of the system application. OAuth2 Server 255 is a protocol that provides specific authorization flows for web applications, desktop applications and mobile devices.

With further regard to the preferred embodiments depicted in the illustrations, the following descriptions of reference numbers are also provided:

### REFERENCE NUMBER

10. Mobile device—The system application is An app-based network of Employers, Employees, Professionals and Clients finding local business opportunities and staffing solutions in real time. The system application is an Enterprise Social Media App that allows a person to connect with another person to share real time availability by skill, time, day of week, hourly rate. This connection provides value to both parties in letting them optimize their appointment setting or shift filling process. The More button provides links to My Skills, My Profile, My Settings, My Companies, Feedback and Logout.
14. Header—This is the homepage for the system application. This screen has the system application logo and tag line “right connection right time” it also includes the “Get Started button and Login button” Users can access the about “what is Open Sim Sim link. Users can access the quick navigation menu at the bottom, which includes a link to “Availability, Jobs, Connection and More”.
16. Get started button—This button navigates visitors to the registration screen where users have two options 1) register via their Facebook credentials 2) register via the standard system application registration process.
17. Add skills—This screen is accessed via the Add My Skills button in the Get Started screen. This screen provides users the ability to define their skills, rate per hour and provide a bio in free form text.
18. Login—This button navigates users to the Login screen. Users will input user name and password or login via Facebook® credentials.
20. About—This link navigates users to the “what is the system application” screen, which provides users with a text and video description of the app.
22. Back—This button navigates users back to the home screen.
24. Text area—There are several areas with text, which are referenced by number 24. Page 2 text area provides text about the system application. Page 6 text area displays a photo. Page 7 text area displays photo and bio information.
26. Facebook® connect—This button allows users to login using their Facebook® credentials.
28. First name—Users first name.
30. Last name—Users last name.
32. Email—Users email address.
34. Password—Users password.
36. Next—This button navigates users to the Get Started screen.
38. Add my skills—This screen is accessed via the Add My Skills button in the Get Started screen. This screen provides users the ability to define their skills, rate per hour and provide a bio in free form text.
40. Find Someone—This button navigates users to the Find Someone page. This page provides the user the ability to look for a skill within a specific location, time range, date range and rate from their connections or anyone registered with the system application.
42. Find Connections—This button navigates users to the Find Connections page. This page provides users with the ability to search for connections and/or invite connections via email or cell phone or by accessing their contact list on their mobile device.
44. Create a Business—This button navigates users to the Create a Business screen (ref 202)
46. Skill—Free form text box to input skills. This will include Autocomplete, which involves the program predicting a word or phrase that the user types. In addition, users will be able to provide a secondary skill (i.e. Chef=primary, Sous Chef=secondary).
48. Maximum hourly rate—Maximum hourly rate for each skill the users creates in their profile.
50. Skill bio—Users have an option to input a description of their experience via free form text.
52. Save—This button saves all entries entered by the user and navigates user to the Skills Added screen. The Skills Added screen provides the option to navigate to the add skills screen (ref 17), navigate to add availability (ref 76) and navigate to view jobs for this skill (ref 140).
54. Shortcut buttons—This toolbar provides users with a quick way to navigate to the Availability screen (ref 60), navigate to Jobs screen (ref 140), navigate to the Connection screen and navigate to the More screen which includes My Skills, Profile view, My Settings, Business details (if business is registered) and a Feedback button.
56. My skills—This screen displays all skills with recommendations for each skill. Users can add or edit skills from this screen.
57. List of skills—This displays skill name, and number of recommendation with a star value for each skill.
58. Name—Name of the user.
60. Availability—This displays the users availability by skill, day, and time. Booked jobs/shifts with skill, location and jobs/shifts applied for.
62. Edit profile—This screen displays photo, bio, name, DOB, with links to the My Skills screen (ref 56) and My Settings screen (ref 74). Phase 2 will include an option to enter a physical address. This will assist with the search filters and geomapping/ETA functionality.
64. Change photo—Provides the user with the ability to change their profile photo.
66. Edit Bio—Provides the user with the ability to update bio details via free form text.
68. Add name—Users has the ability to change their name.
70. Date of Birth—User has the option to input date of birth.
72. Update—This button saves the changes made by the users.
74. My settings—This link navigates the user to the Setting screen (search radius, miles/kms, language and notification settings.
76. Add availability—This screen provides the user with the ability to enter availability, by skill. This includes the start and end time, min hourly rate, and an option to repeat the cycle.
78. Date—day month and year of the users availability.
80. Start time—Start time of the users availability for the selected date or date range.
82. End time—End time of the users availability for the selected date or date range.
84. Minimum hourly rate—Min hourly rate for the selected date, time and skill.
86. Repeat—User can repeat availability setting weekly, fortnightly or monthly.
88. Save—This button saves the settings and navigates the user to Availability Added screen (ref 90).
90. Availability added—This screen provides links to push the users availability to their connections (ref 92) and the option to return to the Add Availability screen (ref 76).
92. Push to connections—This will push availability out to users connections.
94. Add more availability—This link navigates the user back to the Add Availability screen (ref 76).
96. Available time—This page displays available dates, times, skills and recommendations for a user.
98. Time available—This displays the date and time of the users availability.
100. List of skills available—This displays the skills with recommendations for the user.
102. Book me—This button allows employers or users looking for a service to book the available time slot displayed for a specific skill or job.
104. Push availability—This button allows users to push their availability to their connections.
106. Search—This screen allows users to search for connections or the system application users to push their availability to.
108. List of available participants—This provides users with a list of the system application users they can push availability to.
109. Check box—Users can select which connection to push availability to.
110. Push availability—This button allows users to push their availability to the selected connections or the system application users.
112. Add connections—This page provides users with the ability to search for connections and/or invite connections via email or cell phone. In addition, the system application will access the users contact list on their phone allowing users to invite connections via their contact list.
114. Search—Users can search for possible connection already registered with the system application.
116. Email of invitees—email address of individuals a user would like to invite into their network.
118. Invite—This button initiates an email or SMS invite message to the selected connection or to the email or cell phone number provided by the user.
120. Connection requests—This screen shows all connection requests and allows the user to accept or ignore a connection request. Users can go to the connection button in the menu at the bottom of the app, which displays all current connections and provides a link to invite more connections.
122. Requester—This is the name of the person making the connection request.
124. Accept request—This accepts the connection request and adds the user to your connection list.
126. Ignore request—This ignores the connection request.
128. Default distance—This allows a user to specify a default distance from their home or current location. This will become part of the search criteria when looking for a service providers or employee to fill a shift.
130. Setting value—This screen allows users to set their settings for the system application. (Search radius, miles/kms, language and notification settings.
132. Notifications—This will provide details to how you send and/or receive push notifications and messages in the system application.
134. Job opening—A user will receive a job or shift notification with the skill, date, time and location. The user can apply or view the details of the job or shift.
136. Apply—A user can apply for the shift or job pushed to the user.
138. View details—A user can view details of the job or shift.
140. Jobs—This screen displays accepted, posted and new jobs.
142. Your accepted jobs—This provides the user with a list of all jobs they have accepted.
144. View all—Depending on which View All button you select, it will display all active jobs, all posted jobs or all job opportunities.
146. Your posted jobs—This list all jobs or shifts that the user needs filled.
148. Job Opportunities—This list all jobs available to the user based on skill and demographics.
150. Find people—This screen provides the user the ability to look for a skill within a location, date range, time range from their connections or anyone registered with the system application.
152. Type of occupation—Type of skill required.
154. Minimum distance—User can specify a defined distance from a given location that they require the skilled worker from.
156. Location name—User can input a city name to use for filtering available workers.
158. Time specifier—User can define a time range for the shift or services required.
160. Earliest time User can define a time range for the shift or services required.
162. Latest time—User can define a time range for the shift or services required.
164. Location—This field allows a user to search from their connections or anyone registered in the system application.
166. More options—This link displays two additional options. Define min/max per hour rate in addition to entering free format text that further details what the job involves.
168. Find—This button searches for connections who meet the criteria of the shift or job request.
170. Found people—This screen provides the user a list of connection who meet the criteria for the shift or job request. You can select the refine search results button, which allows the user to specify per hour rate range and additional information for the job.
172. Summary—This displays an overview of how many candidates the system found based on the criteria selected for the job or shift search.
174. Job seeker—Name, recommendations, location, distance from job and ETA for the person who meets the criteria for the shift or job.
176. Distance from job—Distance from job or shift location. This uses geomapping.
180. Push job—This button allows users to push a job and/or shift to the selected connections or the system application users.
182. Posted jobs header—This screen provides a list of all jobs and/or shifts required by the user.
184. List of posted jobs—This screen provides a list of all jobs, either the number of applicants or the person who has been booked for the job and/or shifts required by the user.
186. Get details button—This screen provides full details of the job and/or shift. It includes where, when, map, and a button to get direction in addition to selecting a button to email or call the requestor.
188. Posted job—This screen provides details of the job and/or shift posted. Details include where, when, who has applied for the job and/or shift and the ability to accept or ignore the applicants.
190. Job posted—Provides details of the job and/or shift.
192. Location of job posted—Location of job and/or shift posted.
194. Time needed—Date and time of job and/or shift request.
198. Job applicant—List of users that have applied for the job and/or shift.
200. Alert of job acceptance—Users will receive an alert once accepted for a job and/or shift and can view the details of the job/shift.
202. Create business—Users can create a business that provides the following features: Filter by employees or clients. (this allows a business user to see only his or her employees and not everyone they are connected to.) View business jobs or shifts (a single view of all shifts and jobs that have been filled). View business availability (a single view of posted shift and/or appointments that are available to my employees/contacts). Push out notification of shift availability and open appointment to their employees. Provide reviews of their employees. Setup administrators of the business so other managers can use the business features. A business can be liked. An administrator of a business can switch to their personal profile by selecting the switch button.
204. Name of business—Name of the business.
206. Type of business—industry of the business
208. Number of employees—Number of employees for the business.
210. Go—This button navigates the user to the Get Started screen (ref 15).
212. Emote digital—This is an example of a name for the registered business.
214. Switch—This button allows users to switch between a business profile and an individual profile.
215. Get started—Upon successful registration and/or login a user will be taken to this screen to input their skills (ref 38), availability (this could be operating hours), look for an available shift and/or post jobs (ref 40) that need to be filled. Find and invite connections (ref 42).
216. Business with job openings—This screen displays available jobs and/or shifts by skill, date and time by a business.
218. Jobs available—This screen displays available jobs and/or shifts by skill, date and time by a business. Business administrators can access the business availability screen, which provides a view of their employee's availability by skill, date and time.
220. Active job—This screen provides details of the job and/or shift posted. Details include where, when, who has applied for the job and the ability to accept or ignore the applicants.
222. Active job summary—Provides details of the job and/or shift.
224. Call—This button initiates a phone call to the user who has requested the job or shift.
226. Email—This button initiates an email to the user who has requested the job or shift.
228. Active job location—Location of job and/or shift posted.
230. Active job time—Date and time of job and/or shift request.
231. Additional comments—Time of job and/or shift request.
232. Map—This screen provides full details of the job and/or shift. It includes where, when, map, and a button to get direction in addition to selecting a button to email or call the requestor.
234. Get directions—This screen provides full details of the job and/or shift. It includes where, when, map, and a button to get direction in addition to selecting a button to email or call the requestor.

The system application API 256 is the system application-programming interface, which consists of a set of routines, protocols and tools. Apache2 257 is an HTTP Web Server while the Nginx (proxy) 258 is a Proxy Server. The System application Front-end mobile layer 259 enables subscriber users to interact with the system application via their mobile device. Phonegap 260 is the mobile development framework produced by Nitobi, purchased by Adobe Systems. It enables software programmers to build applications for mobile devices using JavaScript, HTML5, and CSS3, instead of device-specific languages such as Objective-C or Java. The system application Front-end desktop layer 261 enables subscriber users to interact with the system application via their desktop computer. Javascript 262 is employed as an object-oriented computer programming language commonly used to create interactive effects within web browsers. Ember 264 and Ember data 263 provides a real web app framework with the ability to build the system application as a one-page app (without refreshing or opening a new page when a subscriber user navigates through the system application. AU transactions and API calls are with one page. When the Ember application is finished, it is ported to a Phonegap to deliver a cross platform mobile application.

In a preferred embodiment of the invention subscriber users will occupy the designation of either Employee subscriber user, Employer subscriber user, Professional subscriber user, Client subscriber user or all of the above. The illustrations and descriptions herein are not intended to limit the scope of the invention to merely the elements provided. It will be understood by one of pertinent skill in the art that other functionalities (i.e., search engine, display features, etc.) are envisioned and within the scope of the invention. A rating system is also employed by subscriber users. The rating system permits users the ability to provide written recommendations for services provided for each skill. Subscriber users will be notified when a recommendation is written and users will be able to delete the recommendation if desired.

In another preferred embodiment, the search engine of the invention employs use of a database on a network server that stores and saves the background and professional qualifications, business information and other attributes pertinent to the subscriber users associated with the mobile device implemented substitute fulfillment system and social networking application (“app”). As envisioned herein, the social networking application employs use of network processors that accurately and automatically match job postings created by employer/client subscriber users to the background and qualifications of employee/professional subscriber users whom may be aware or unaware of the available job posting.

The system and methods herein also employ non-automated matching between job and job qualifications posted to the system by an employer/client subscriber user and an employee/professional subscriber user possessing desired skills as outlined in the job posting description. The non-automated process includes for example, review of one or more job opportunities posted by an employer/client subscriber user on the system, the posting outlining details and desired job qualifications necessary for the position

To prepare the “app” or application for mobile device, methods as are known in the art are generally employed and include creation of a network server capable of saving background information on subscriber users, companies and job descriptions. The communication link of the network server encompasses internet or mobile device connections including for example Wi-Fi connectivity. The invention employs use of the network server to receive job postings and employment opportunities, permanent as well as temporary, posted by employer/client subscriber users and make the job postings and employment opportunities viewable on a mobile device “app” or internet interface via website.

Likewise, creation of the web based, online version of the system and methods employ traditional methods of web based design as are generally known in the art.

Certain advantages can be obtained in utilizing the present invention. Foremost, the invention allows a subscriber user the ability to efficiently and accurately push their real time availability by skill set and review available job opportunities that fit his or her professional qualifications and skill set conveniently from any smart phone or mobile device, as well as online via the internet.

Although the invention has been described with reference to the above examples, it will be understood that modifications and variations are encompassed within the spirit and scope of the invention. Accordingly, the invention is limited only by the following claims

What is claimed is:

1. A method of engaging in employment networking through a mobile device implemented job placement and recruitment system wherein said mobile device implemented job placement and recruitment system comprises a social networking application (“app”) wherein said social networking application comprises software that allows a subscriber user to establish network connections to one or more other subscriber users all whom possess access to said social networking application, said subscriber users being designated as employer subscriber users, employee subscriber users, professional subscriber users, client subscriber users or any combination of said designations, wherein said social networking application allows said employer subscriber user to create an employer account profile via said software, wherein said employer subscriber user includes business information, professional background and business industry into said employer account profile, wherein said employer subscriber user can input one or more job opportunities into said employer account profile that are posted on said social networking application, said one or more job opportunities being viewable by means of said social networking application by said employee subscriber users wherein said employer subscriber user enters job required information into said one or more job opportunities, said job required information including desired candidate qualifications for said one or more job opportunities, said candidate qualifications including preferred professional background, desired time of availability, desired geographical location of qualified candidates and desired start date of said one or more job opportunities, wherein said social networking system further includes software that allows said employer subscriber user to conduct one or more searches of potential employee subscriber users to fill said one or more job opportunities, wherein said potential employee subscriber users are either within said employer subscriber user's network connections or outside of said employer subscriber user's network connections, wherein said search generates a results list of said potential employee subscriber users, wherein search criteria is directed to said employee subscriber users whose professional background, geographical location and availability match the requirements of said one or more job opportunities, wherein said one or more job opportunities generated in said results list are pushed electronically to said potential employee subscriber users by means of said software, wherein said potential employee subscriber users view said one or more job opportunities and details thereof, wherein said potential employee subscriber users apply for said one or more job opportunities by electronically pushing said potential employee subscriber user's said professional background and availability to said potential employee subscriber user's account for viewing by a potential employer subscriber user, wherein said potential employee subscriber user's account information includes professional background, availability by skill, job qualifications, review by skills, geographical location and other attributes that match said desired candidate qualifications for said one or more job opportunities, wherein said employer subscriber user, by making a selection by means of said software, either retains the services of said potential employee subscriber user by electronically selecting said potential employee subscriber user for said one or more job opportunities or declines to retain said potential employee subscriber user's services for said one or more job opportunities wherein, if retained, said employee subscriber user is employed by said employer subscriber user directly.

2. The method of claim 1 wherein said social networking system includes software comprising a means to allow said employee subscriber user to conduct one or more searches of said one or more job opportunities, wherein said one or more job opportunities have been posted by said employer subscriber users whom are either within said employee subscriber user's network connections or outside of said employee subscriber user's network connections, wherein said social networking system software further comprises a means to allow said employee subscriber user to actively push said employee subscriber user's account and professional background information to said one or more job opportunities that match said employee subscriber user's said professional background wherein, said social networking application further comprises a substitute fulfillment system, wherein said social networking application places said employee subscriber users into permanent or temporary employment.

3. The method of claim 2 wherein said employee subscriber user account includes resume information including school history, employment background and history, geographical location, previous employers, recommendations, professional goals, name and contact information, wherein said employee subscriber users provide an internet link on said software to other sites to allow access to resume information.

4. The method of claim 2 wherein said social networking application comprises a means of automatically notifying said employee subscriber users of new job postings which require said professional background and availability that match said employee subscriber user's said resume information, wherein said notification occurs when said employee subscriber user receives a text, email and/or screen pop that is sent automatically from said social networking application software.

5. The method of claim 2 wherein said social networking application comprises software that allows said employer subscriber user to actively push notification of said one more job opportunities posted on said social networking application to said employee subscriber users whose professional background matches said job required information and said professional background requirements described in said one or more job opportunities wherein said notification occurs when said employee subscriber user receives a text, email and/or screen pop that is sent from said social networking application software.

6. The method of claim 2 wherein said account profiles are stored on one or more network servers wherein, said account information is further stored on a database configured to store information and attributes received from said subscriber users wherein said account information is accessible to computer processors so that said account information is analyzed in the course of said search of potential employee subscriber users or said search of available said one or more job opportunities.

7. The method of claim 2 wherein said one or more job opportunities require that said potential employee subscriber users to be located within a specified geographical area as specified in descriptions of said one more job opportunities.

8. The method of claim 2 wherein said software comprises a means to allow said employee subscriber user to enter into search parameters said desired attributes of said one or more job opportunities including hourly rate, day and times for which said employee subscriber user is available to work, wherein said one or more job opportunities comprise permanent or temporary employment.

9. The method of claim 8 wherein said software comprises a means to allow said employer subscriber user to select a suitably qualified employee subscriber user thereby hiring said employee subscriber user for employment.

10. The method of claim 8 wherein said software further comprises a means to allow said employer subscriber user to create and send a priority invitation message wherein said priority invitation message comprises an email, text or screen pop up communicating an urgent and immediate need to fill an employment opportunity, wherein said priority invitation message is sent to network connected employee subscriber users whom possess the required job skills, however whom do not have current availability, wherein said priority invitation message alerts said network connected employee subscriber users to said employment opportunity, wherein said network connected employee subscriber users would not have otherwise been made aware of said employment opportunity.

11. The method of claim 10 wherein said priority invitation message is created comprising the following steps:
a. said employer subscriber user inputs requirements for a shift said employer subscriber user has a need to fill wherein said requirements are entered into said software including desired skills, shift times, geographical location and pay rate;
b. said software conducts searches for employee subscriber users from within said employee subscriber user's network connections whom meet all requirements of said employment opportunity;
c. in instances in which no suitable employee subscriber users are identified by said searches said software identifies employee subscriber users within said employee subscriber user's network whom do not have current availability for said employment opportunity;
d. said software creates and forwards a priority invitation message to said identified employee subscriber users whom do not have current availability for said employment opportunity wherein said identified employee subscriber user can accept or decline the position for said employment opportunity;
e. in instances in which all of said identified employee subscribers decline said employment opportunity said employee subscriber user expands said priority invitation message to employee subscriber users outside of said employer subscriber user's network connections wherein said employee subscriber users outside of said employer subscriber user's network possess the skills and professional background required for said employment opportunity;
f. in instances in which said identified employee subscriber accepts said position for said employment opportunity and is unable to fulfill the obligations of said employment opportunity, said identified employee subscriber becomes responsible for locating a suitable replacement for said identified employee subscriber in fulfilling said obligation of said employment opportunity.

12. The method of claim 11 wherein said employee and employer subscriber account profiles are visible only to said subscriber users whom are connected with said employee and employer subscribers otherwise only month and year of membership, number of recommendations and geographical location of said employee and employer users are visible unconnected subscriber users.

13. The method of claim 12 wherein said software comprises online guides that convey information to said employee and employer subscriber users as to the process of adding said connections to said user account profiles, hiring said users, searching for said employment opportunities and creating a user profile.

14. The method of claim 13 wherein said subscriber user creates and sends an electronic email or text message by means of said software to one or more individuals whom are non subscriber users, wherein said electronic message comprises a connection request for said one or more non subscriber users to become subscriber users to join said subscriber user's network connections, wherein said connection request comprises a link wherein said one or more non subscriber users accesses and downloads said software, wherein following downloading said software said one or more non subscriber users become a part of said subscriber user's network.

15. The method of claim 14 wherein said mobile device implemented job placement and recruitment system comprises assigned, pre-defined permissions and access of said subscriber account profiles wherein said assigned, pre-defined permissions are determined and input into said software by said subscriber users wherein said access is based on said subscriber user's role and responsibility within said subscriber user's particular business and company wherein said pre-defined permissions and access comprise one or more tiers, said tiers comprising full access to all features and functionality of said software, wherein comprehensive permissions comprises access to all of said features and functionality or access on a limited basis wherein said limited basis comprises access to only basic features and functionality of said software.

16. The method of claim 15 wherein said mobile device implemented job placement and recruitment system comprises a language translator wherein said translator comprises a language setting that allows said subscriber users to select a preferred language in which to receive and send correspondences via said software.

17. A method of engaging in employment networking through a mobile device implemented job placement and recruitment system wherein said mobile device implemented job placement and recruitment system comprises a social networking application (“app”) wherein said social networking application comprises software that allows a subscriber user to establish network connections to one or more other subscriber users all whom possess access to said social networking application, said subscriber users being designated as employer subscriber users, employee subscriber users, professional subscriber users, client subscriber users or any combination of said designations, wherein said social networking application comprises a means of allowing a client subscriber user of to create a client account profile, wherein said client subscriber user includes in said account profile, business information, professional background and business industry, wherein said client subscriber user creates one or more job opportunities by means of said software that are posted on said social networking application by said client subscriber user, said one or more job opportunities being viewable on said social networking application by said professional subscriber users, wherein said professional subscriber users create a professional subscriber user account, wherein said client subscriber user enters job required information into said one or more job opportunities, said job required information including desired candidate qualifications for said one or more job opportunities, said candidate qualifications including preferred professional background, desired time of availability, desired geographical location of said candidate and desired date of said one or more job opportunities, wherein said social networking system further comprises software that allows said client subscriber user to conduct one or more searches of potential professional subscriber users to fill said one or more job opportunities, wherein said potential professional subscriber users are either within said client subscriber user's network connections or whom are outside of said client subscriber user's network connections, wherein search criteria employed in said one or more searches is limited to professional subscriber users whose professional background, geographical location and availability match the requirements of said one or more job opportunities, wherein said one or more job opportunities are pushed electronically to said potential professional subscriber users by means of said software, wherein said potential professional subscriber users view said one or more job opportunities and details thereof by means of said software, wherein said potential professional subscriber users apply for said one or more job opportunities by electronically pushing said potential professional subscriber user's said professional account information and said candidate qualifications to said potential client subscriber user's account for viewing by said potential client subscriber users, wherein said potential professional subscriber user's account information includes said professional background, availability by skill, job qualifications, review by skills, geographical location and other attributes that match said desired candidate qualifications for said one or more job opportunities, wherein said client subscriber user, by means of said software, either hires one or more of said potential professional subscriber users by electronically selecting said one or more potential professional subscriber users for said one or more job opportunities or declines to retain said potential professional subscriber user's services, wherein if retained, said one or more professional subscriber users is employed by said client subscriber user directly.

18. The method of claim 17 wherein said social networking system includes software comprising a means wherein said professional subscriber users conduct one or more searches of said one or more job opportunities, wherein said one or more job opportunities have been posted by said client subscriber users whom are either within said professional subscriber user's network connections or outside of said professional subscriber network connections, wherein said social networking system comprises software that allows said professional subscriber users to push said professional subscriber user's account information and said professional background information to said one or more job opportunities that match said professional subscriber user's said professional background wherein, said social networking application comprises a substitute fulfillment system, wherein said social networking application places said employee subscriber users into permanent or temporary employment.

19. The method of claim 18 wherein said social networking application comprises software that automatically notifies said professional subscriber users of new job postings which require a professional background that matches said professional subscriber user's said professional background with a text, email and/or screen pop that is sent by means of said social networking application software to said professional subscriber user's mobile device.

20. The method of claim 19 wherein said social networking application comprises software that allows said client subscriber user to actively push notification of said one more job opportunities posted on said social networking application to said professional subscriber users whose professional background match the professional background requirements described in said one or more job opportunities, wherein said notification occurs when said professional subscriber user receives a text, email and/or screen pop that is sent from said social networking application software on said professional subscriber user's mobile device.

21. The method of claim 19 wherein said automatic notification is generated from a database and computer processor, wherein said one or more job opportunities are stored on said database containing said subscriber user account profiles including said one or more job opportunities, wherein said database and said computer processor analyzes available subscriber user accounts that contain one or more job opportunities and matches job qualifications listed in said one or more job opportunities with the qualifications of said professional subscriber users, wherein said matching generates a results list of said one or more job opportunities that is emailed, sent via text message or a screen pop automatically to said professional subscriber user.

22. The method of claim 21 wherein said pushed one or more job opportunities are generated by means of said software from a search conducted by said client subscriber users, wherein said search employs search criteria to match desired job qualifications with the qualifications of available professional subscriber users on said social networking application, thereby generating a results list, said results list being sent to said client subscriber users by means of said software, wherein said professional subscriber users are either within said client subscriber user's network connections or outside of said client subscriber user's network connections.

23. The method of claim 22 wherein said one or more job opportunities are pushed actively from said client subscriber user to said professional subscriber users by means of said software, said client subscriber users being knowledgeable that the desired job qualifications relating to said one or more job opportunities match the professional background of said professional subscriber user receiving said pushed one or more job opportunities, wherein said professional subscriber user is either within said client subscriber user's network connections or outside of said client subscriber user's network connections.

24. A method of engaging in employment networking through a mobile device implemented job placement and recruitment system, wherein said mobile device implemented job placement and recruitment system comprises a social networking application (“app”) wherein said social networking application comprises software that allows an employer/client subscriber user to post one or more job opportunities on said employer/client subscriber user's account profile, wherein said employer/client subscriber user is also designated as an employee/professional subscriber user in the instance in which said employer/client subscriber user applies for a position posted on said social networking application, thereby allowing said employer/client subscriber user to be designated as both an employer/client and employee/professional subscriber user wherein said software further comprises a means to allow said employee/professional subscriber users to apply to said one or more job opportunities, wherein said employer/client subscriber users hire said employee/professional subscriber users directly.

25. The method of claim 24 wherein a schedule of temporary or permanent employment opportunities is created by means of said software such that said temporary or permanent employment opportunities and availability of an employee/client subscriber user is displayed in table form viewable by other subscriber users within said employee/client subscriber user's network connections.

26. The method of claim 25 wherein said employee/client subscriber users can upload an introductory video to said account profile, said video outlining the employee/client subscriber user's professional background, skills and other business related information.

27. The method of claim 25 wherein said subscriber users can create and send video messages to other subscriber users either within or outside of said subscriber user's network connection network.

28. The method of claim 25 wherein said software comprises a means of allowing said employer/client subscriber users and said employee/professional subscriber users to conduct searches of either one or more job opportunities, one or more potential employee/professional subscriber users or both by employing use of said software, wherein said software analyzes and processes the professional background, location and availability of one or more subscriber users and generates a results list, wherein said software comprises real time push notification and geomapping to establish a reliable estimated time of arrival (ETA) of said potential employee/professional subscriber users to job sites, wherein said employee/professional subscriber users are needed to work available said one or more job opportunities, wherein said software processes the professional background of said subscriber users stored in a database, wherein said software generates a results list that provides said employer/client subscriber users with potential employee/professional subscriber users whom can fill work shifts, wherein said social networking application comprises a means that allows said employee/professional subscriber users and employer subscriber users to establish network connections to one another so that there is instant visibility of available individuals by their skills, time of day, day of week, hourly rate, recommendations and ETA information on said subscriber user's account profile.

29. The method of claim 28 wherein said software comprises a means of allowing said employee/professional subscriber users to upload their current employer/client information, past employer/client information, number of recommendations, current shift and job to which said employee/professional subscriber user is working and for whom said employee/professional subscriber user is working those shifts and job, wherein said employee/professional subscriber user's list of network connections are visible to said employer/client subscriber users.

30. The method of claim 29 wherein said real time push notification comprises a means of allowing said employee/professional subscriber users to update said employee/professional subscriber user's availability so to take new job assignments in real time, wherein said employee/professional subscriber users can cancel said one or more job opportunities, wherein said employee/professional subscriber's availability is automatically updated on said social networking application and displayed in table form, said table form being viewable to subscriber users within said employee/professional subscriber user's network connections.
